(19) United States
(12) Patent Application Publication
(10) Pub. No.: US 2008/0273520 A1
(43) Pub. Date: Nov. 6, 2008

(54) NETWORK ARCHITECTURE FOR DYNAMICALLY SETTING END-TO-END QUALITY OF SERVICE (QoS) IN A BROADBAND WIRELESS COMMUNICATION SYSTEM

(75) Inventors: Ki-Back KIM, Seongnam-si (KR); Dong-Soo PARK, Seoul (KR); Dae-Woo LEE, Seoul (KR); Ji-Cheol LEE, Yongin-si (KR); Jung-Shin PARK, Seoul (KR); Seong-Min KIM, Seoul (KR)

Correspondence Address: Jefferson IP Law, LLP, 1730 M Street, NW, Suite 807, Washington, DC, 20036, US

(73) Assignee: Samsung Electronics Co. Ltd., Suwon-si (KR)

(21) Appl. No.: 12/113,075

(22) Filed: Apr. 30, 2008

(30) Foreign Application Priority Data
May 4, 2007 (KR) 2007-0043779
May 4, 2007 (KR) 2007-0043780
Sep. 28, 2007 (KR) 2007-0097731
Sep. 28, 2007 (KR) 2007-0097732
Mar. 3, 2008 (KR) 2008-0019821

(51) Int. Cl. H04J 3/00

(52) U.S. Cl. 370/345; 370/310

(57) ABSTRACT

A communication network architecture including a broadband radio access network is provided. The architecture includes a terminal for transmitting an application layer service request message to request a service, a Policy Charging Rule Function (PCRF) for generating Quality of Service (QoS) parameters of an Internet Protocol (IP) layer using QoS parameters of an application layer contained in the application layer service request message, a first Policy Decision Function (PDF) for generating one or more QoS parameters of the IP layer in addition to the IP layer QoS parameters generated at the PCRF and a second PDF for generating a QoS parameter set of a radio access network using the IP layer QoS parameters generated at the PCRF and the one or more IP layer QoS parameters generated at the first PDF. The communication network guarantees an end-to-end QoS.

### PRIORITY

This application claims the benefit under 35 U.S.C. § 119(a) of a Korean patent application filed in the Korean Intellectual Property Office on May 4, 2007 and assigned Serial No. 2007-43779, a Korean patent application filed in the Korean Intellectual Property Office on May 4, 2007 and assigned Serial No. 2007-43780, a Korean patent application filed in the Korean Intellectual Property Office on Sep. 28, 2007 and assigned Serial No. 2007-97731, a Korean patent application filed in the Korean Intellectual Property Office on Sep. 28, 2007 and assigned Serial No. 2007-97732, and a Korean patent application filed in the Korean Intellectual Property Office on Mar. 3, 2008 and assigned Serial No. 2008-19821, the entire disclosures of each of which are hereby incorporated by reference.

### BACKGROUND OF THE INVENTION

1. Field of the Invention The present invention relates generally to a broadband network architecture. More particularly, the present invention relates to a network architecture including a broadband radio access network to guarantee end-to-end Quality of Service (QoS).

2. Description of the Related Art

Past communications systems have been developed by focusing only on system capabilities such as radio capacity of the system and a service rate. However, in response to several factors, such as the increase of service types, the increase of traffic congestion and the increase in diversity of user's service requirement level, present-day communications systems are operated by taking into account a Quality of Service (QoS). The QoS indicates the system capabilities and a user satisfaction. In addition, since channel environments vary with time and since the mobility of a terminal may change the amount of available resources, a wireless communication system requires a policy that considers various situations to guarantee the QoS. Furthermore, since users of a communication network demand various services at a high rate, a QoS policy is gaining much attention to effectively control the change of the radio resource and the traffic.

To provide satisfactory services to the user, it is necessary to ensure an end-to-end QoS. The end-to-end QoS, which is a QoS of an application layer between a service provider and a terminal or between terminals, implies the QoS experienced by the user. To guarantee the end-to-end QoS, interworking procedures are required to ensure the overall QoS in relation with an Internet Protocol (IP) layer and a Media Access Control (MAC) layer below the application layer.

However, current broadband communication networks do not offer a method for the interworking procedures to guarantee the QoS. The MAC layer of the broadband communication network, that is the radio access network, conforms to the Institute of Electrical and Electronics Engineers (IEEE) 802.16 specification. Naturally, the QoS process of the MAC layer between a terminal and a base station is defined, whereas an overall interworking procedure for an access network and a core network to ensure the QoS is not yet defined. Therefore, what is needed is a method for the interworking management to guarantee the end-to-end QoS in the communication network.

### SUMMARY OF THE INVENTION

An aspect of the present invention is to address at least the above mentioned problems and/or disadvantages and to provide at least the advantages described below. Accordingly, an aspect of the present invention is to provide a communication network architecture for an end-to-end Quality of Service (QoS).

Another aspect of the present invention is to provide a communication network architecture for setting a dynamic QoS.

Yet another aspect of the present invention is to provide a communication network architecture for generating QoS parameters of a radio access network using QoS parameters of an application layer.

Still another aspect of the present invention is to provide a communication network architecture for setting QoS of a Media Access Control (MAC) layer, which is initiated by a terminal or a base station.

A further aspect of the present invention is to provide a communication network architecture for efficiently setting QoS of a MAC layer by taking into account resources and latency.

Still a further aspect of the present invention is to provide a communication network architecture for supporting both an IMS-based dynamic QoS setting using SIP and a web-based dynamic QoS setting using an HTTP.

According to an aspect of the present invention, a communication network architecture is provided. The architecture includes a terminal for transmitting an application layer service request message to request a service, a Policy Charging Rule Function (PCRF) for generating Quality of Service (QoS) parameters of an Internet Protocol (IP) layer using QoS parameters of an application layer contained in the application layer service request message, a first Policy Decision Function (PDF) for generating one or more QoS parameters of the IP layer in addition to the IP layer QoS parameters generated at the PCRF and a second PDF for generating a QoS parameter set of a radio access network using the IP layer QoS parameters generated at the PCRF and the one or more IP layer QoS parameters generated at the first PDF.

According to another aspect of the present invention, a communication network architecture is provided. The network architecture includes a terminal for transmitting an application layer service request message to request a service, a PCRF for generating QoS parameters of an IP layer using QoS parameters of an application layer contained in the application layer service request message and a PDF for generating a QoS parameter set of a radio access network, or one or more QoS parameters of the IP layer in addition to the IP layer QoS parameters generated at the PCRF using the QoS parameters of the IP layer.

According to yet another aspect of the present invention, a communication network architecture is provided. The network architecture includes a terminal for transmitting an application layer service request message to request a service, a first server for managing user class information of the terminal, a second server for acquiring QoS information of an application layer from the service request message of the terminal and a policy function for generating a QoS parameter set of a radio access network using the application layer QoS information and the user class information.

According to still another aspect of the present invention, a communication network architecture is provided. The network architecture includes a terminal for transmitting an application layer service request message to request a service, a first function for horizontally switching QoS parameters of different application layers between Service Providers (SPs) when a server which handles QoS parameters of an application layer is operated by different SPs, a second function for horizontally switching QoS parameters of different IP layers when a server function for handling QoS parameters of application layers operated by different SPs is the same but a PCRF is different, a third function for horizontally switching QoS parameters of different IP layers when a server and a PCRF for handling QoS parameters of application layers operated by different SPs operate the same but a first PDF is different and a fourth function for horizontally switching QoS parameters of different radio access networks when a server, a PCRF, and a first PDF for handling QoS parameters of application layers operated by different SPs operate the same but a second PDF is different.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments the present invention will become more apparent from the following detailed description taken in conjunction with the accompanying drawings, in which:

FIG. 1 is a simplified diagram illustrating a communication network according to an exemplary embodiment of the present invention;

FIG. 2 is a layer architecture of Network Entities (NEs) in a communication network according to an exemplary embodiment of the present invention;

FIG. 3 is a signal exchange diagram between NEs in a communication network according to one exemplary embodiment of the present invention;

FIG. 4 is a signal exchange diagram between NEs in a communication network according to another exemplary embodiment of the present invention;

FIG. 5 is a signal exchange diagram between NEs in a communication network according to yet another exemplary embodiment of the present invention;

FIG. 6 is a signal exchange diagram between NEs in a communication network according to still another exemplary embodiment of the present invention;

FIG. 7 is a signal exchange diagram between NEs in a communication network according to further exemplary embodiment of the present invention;

FIG. 8 is a signal exchange diagram between NEs in a communication network according to further exemplary embodiment of the present invention;

FIG. 9 is a block diagram illustrating a policy function device in a communication network according to an exemplary embodiment of the present invention;

FIG. 10 is a block diagram illustrating a terminal in a communication network according to an exemplary embodiment of the present invention;

FIG. 11 is a block diagram illustrating a base station in a communication network according to an exemplary embodiment of the present invention;

FIG. 12 is a flowchart illustrating operations of a policy function device in a communication network according to an exemplary embodiment of the present invention;

FIG. 13 is a flowchart illustrating operations of a terminal in a communication network according to an exemplary embodiment of the present invention;

FIG. 14 is a flowchart illustrating operations of a terminal in a communication network according to an exemplary embodiment of the present invention; and

FIG. 15 is a flowchart illustrating operations of a base station in a communication network according to another exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The present invention provides an interworking technique between Network Entities (NEs) for setting a dynamic Quality of Service (QoS) in a communication network including a broadband radio access network. Hereinafter, names of the NEs in the system are defined according to their function. Accordingly, the names of the NEs may differ depending on an intention of a system operator or a user. For example, a Base Station (BS) may be a Radio Access Station (RAS). In addition, an Access Service Network_Gateway (ASN_GW) may be an Access Control Router (ACR). The ASN_GW may also function as a router.

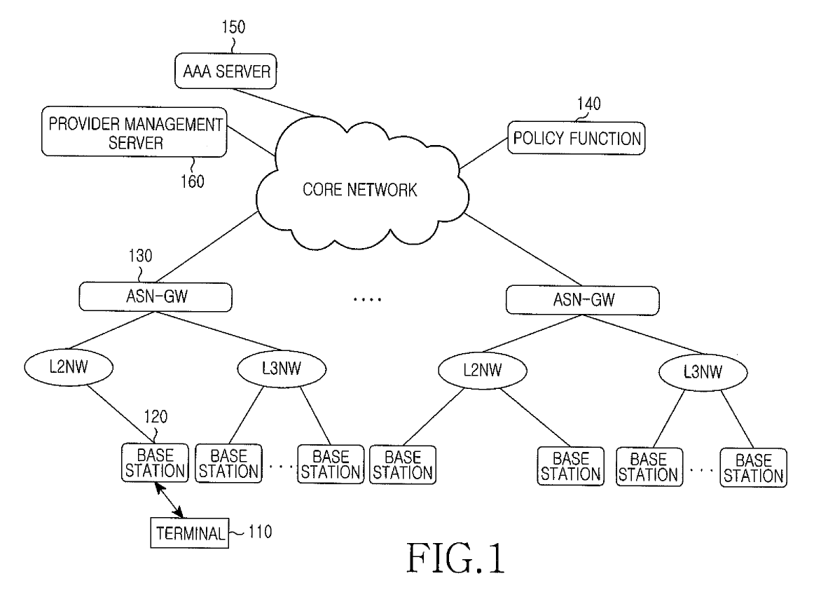

FIG. 1 is a simplified diagram illustrating a communication network according to an exemplary embodiment of the present invention.

The communication network of FIG. 1 includes a terminal 110, a base station 120, a Access Service Network_GateWay (ASN_GW) 130, a policy function 140, an Authentication Authorization Accounting (AAA) server 150, and a provider management server 160.

The terminal 110 designates terminal-end equipment by which a user accesses a network to use the service. The base station 120 manages radio resources for the network access of the terminal 110. The base station 120 can be implemented by a Radio Access Station (RAS), a Base Station (BS) and the like.

The ASN_GW 130 serves as a gateway of a subnet including a plurality of BSs. The ASN_GW 130 can be implemented by an Access Control Router (ACR) and the like. Namely, the ASN_GW 130 acts as an upper node of multiple base stations. The ASN_GW 130 manages Service Flow (SF), connection, and mobility of the terminal 110. In an exemplary implementation, the SF is generated for an UpLink (UL) and a Downlink (DL) separately.

The policy function 140 defines QoS parameters of a radio Access Network (AN) by reflecting a policy of the system operator. Note that the policy function 140 denotes a functional element and thus can be provided as an independent server or can be included in another NE as one of its functions. For example, an Internet Protocol (IP) Multimedia Subsystem (IMS) server using a Session Initiate Protocol (SIP) can include the policy function 140. In this case, one server can be constituted solely with a Proxy-Call State Control Function (P-CSCF) of the IMS server and the policy function. The P-CSCF is a function block of the IMS, which receives an SIP message from the user. Namely, the P-CSCF is a sort of interface block. Herein, the policy function 140 can be divided to two parts; a Policy Charging Rule Function (PCRF) and a Policy Decision Function (PDF), which will be explained in detail below.

The policy function 140 determines the QoS parameters of the radio access network according to the policy of the provider. Hence, when the provider changes its policy, the policy function 140 defines different QoS parameters even with the same input variables. When the policy of the provider is altered, the QoS parameters defined before the policy change and the QoS parameters sustained after the change of the policy are processed as described below.

Firstly, the policy function 140 sustains the preset QoS parameters until the corresponding service expires. Secondly, the policy function 140 newly defines QoS parameters through a Dynamic Service Change (DSC). It is not allowed to newly generate or delete the SF. Thirdly, the policy function 140 newly sets the QoS parameters through the DSC. In doing so, the SF can be newly generated or deleted.

The AAA server 150 manages authentication information and charging information of the terminals. With respect to terminals allowed to be serviced by the corresponding provider, the authentication information pertains to the service use qualification of the terminals. The authentication information can be represented using user classes. For example, premium, gold, silver, and bronze classes, which can be managed by a Subscriber Profile Repository (SPR). The SPR can be a constituent of the AAA server 150. Alternatively, the SPR can be included in another server or provided as a separate server. The PCRF can acquire necessary user information in association with the SPR and utilize the acquired user information as input parameters to change the QoS parameters of the application layer to the QoS parameters of the IP layer.

The charging information relates to a charge imposed on the user for the service of the terminal. The charge is imposed with respect to a time period where the actual SF is active. When the terminal travels, ASN_GWs which are responsible for the start point, the mid point, and the end point of the traffic flow may differ. The AAA server 150 computes the charging time by receiving the actual serving times from the ASN_GWs. Alternatively, each ASN_GW provides the other ASN_GWs with the active time information accumulated when the terminal moves around. The AAA server 150 computes the charging time by receiving the accumulated active time information from the serving ASN_GW of the service end point. If the terminal 110 has a Subscriber Identity Module (SIM) card, the terminal 110 can handle the charging by itself. When the terminal 110 itself processes the charge, the charging time information is provided from the AAA server 150 to the terminal 110, provided from the ASN_GWs to the terminal 110, or computed by the terminal 110.

The provider management server 160 manages the network of the provider. The provider management server 160 can be a Wibro System Manger (WSM), an Element Management System (EMS) and the like. The provider management server 160 provides network configuration information to the components of an Access Service Network (ASN) and manages the components of the ASN. Herein, the ASN indicates one or more subnet sets managed by the same provider.

The QoS interworking management according to an exemplary embodiment of the present invention is described by referring to FIG. 1.

When the user wants to use a specific service using the terminal 110, the terminal 110 enters the network through the initial access procedure with the base station 120 and then communicates with a correspondent node of the corresponding service. Herein, when the service is a Voice over IP (VoIP) service, the correspondent node is another terminal. When the service is a video streaming service, the correspondent node is a service providing server.

To guarantee the QoS per SF, the base station 120 and the ASN_GW 130 need to set QoS parameters of the MAC layer, the IP layer, and the Ethernet layer in accordance with the characteristics of the service requested by the terminal 110. For doing so, the policy function 140 confirms QoS information of the application layer based on a service request message of the application layer received from the terminal 110, and generates QoS parameters to be used at the terminal 110, the base station 120, and the ASN_GW 130.

To this end, the policy function 140 should acquire the authentication information of the terminal 110 which requests the service. The policy function 140 acquires the authentication information directly from the AAA server 150, or acquires authentication information which is obtained by an anchor ASN_GW of the terminal 110 by interworking with the AAA server 150, from the anchor ASN_GW. The policy function 140 generates a QoS parameter set of the radio access network according to the authentication information and the QoS information of the application layer. The QoS parameter set includes QoS parameters of the MAC layer, the IP layer, and the Ethernet layer. For example, the QoS parameters of the MAC layer can be QoS parameters of the Institute of Electrical and Electronics Engineers (IEEE) 802.16, the QoS parameters of the IP layer can be Differentiated Services Code Point (DSCP), and the QoS parameters of the Ethernet layer can be Class of Service (CoS). Yet, depending on the policy, the policy function 140 may not directly output the DSCP and the CoS. In this case, the provider can input a mapping table of the QoS class types, the DSCP, and the CoS to the provider management server 160 so that the base station 120 and the ASN_GW 130 generate the DSCP and the CoS based on the mapping table. More specifically, the ASN_GW 130 marks the DSCP and the CoS on DL packets according to the QoS class type, and the base station 120 marks the DSCP and the CoS on UL packets according to the QoS class type. The ASN_GW 130 remarks the marking of the base station 120 on the UL traffic transmitted from the ASN_GW 130 to the core network. The policy function 140 determines a ClaSsification (CS) rule to distinguish the multiple SFs of one terminal. Herein, the CS rule of the terminals may differ or be the same. In an exemplary embodiment of the present invention as described below, it is assumed that the CS rule differs on the terminal basis. The policy function 140 determines the CS rule. For instance, a reference parameter of the CS rule can be 5-tuple or 6-tuple information. The 5-tuple information includes a source IP address, a destination IP address, a source port, a destination port, and a protocol IDentifier (ID). The 6-tuple information includes the 5-tuple information and a Type of Service (ToS).

The QoS parameter set and the CS rule generated by the policy function 140 are provided to the terminal 110 or the base station 120 for using them to generate the SF in the radio access network. Herein, the radio access network represents a network covering the ASN_GW 130, the base station 120, and the terminal 110.

If a terminal in an awake mode or in a sleep mode moves out of the subnet of the anchor ASN_GW where initial parameters are set and hands over to another subnet, the QoS parameters are sustained as follows. When the handed terminal does not change its anchor ASN_GW, the anchor ASN_GW provides the QoS parameters to the serving base station by tunneling with the ASN_GW of the subnet of the terminal or directly through an L2 extension. The L2 extension signifies that the ASN_GW connects to a base station out of its subnet through IP communications. At this time, when the ASN is changed, the tunneling is preferred. When the ASN is not changed, both of the tunneling and the L2 extension are applicable.

By contrast, when the anchor ASN_GW of the handed terminal is changed, the anchor ASN_GW provides the CS rule and the QoS parameters to the ASN_GW of the subnet of the terminal and the ASN_GW forwards the received CS rule and the received QoS parameters to the serving base station.

When a terminal in an idle mode moves out of the subnet of the anchor ASN_GW and hands over to another subnet, the CS rule and the QoS parameters are provided from the anchor ASN_GW to the ASN_GW of the subnet of the terminal.

When the terminal 110 is handed over between heterogeneous networks, the QoS parameters cannot be forwarded and used because the QoS parameters of the heterogeneous networks may differ. Typically, the terminal handed over to the heterogeneous network passes through an initial network entry procedure in a new system and then performs the QoS setting procedure. In doing so, the initial network entry procedure causes a service delay. To reduce the delay time until the QoS parameters are set, the policy function 140 can provide the target system policy function with input variables for setting QoS. An exemplary method of forwarding the input variables is now described.

Firstly, the ASN_GW 130 informs a target ASN_GW of an address of the policy function 140, and the target ASN_GW informs the target system policy function of the address of the policy function 140. Secondly, the ASN_GW 130 obtains an address of the target system policy function from the target ASN_GW and informs the policy function 140 of the address of the target system policy function. The policy function 140 forwards the input variables and the target system policy function acquires the input variables by interworking between the policy function 140 and the target system policy function. Herein, the number and the type of the input variables may differ between the two systems. In such a case, separate device can be provided to convert the different input variables.

The target system policy function determines the QoS parameters and the CS rule using the obtained input variables. The target ASN_GW defines new QoS parameters through the DSC with the terminal 110.

Similar to the above input variable forwarding scheme, the user class information is forwarded between the AAA server 150 and a target system AAA server. Also separate converting device can be provided to convert the user class information.

The different providers of the heterogeneous network result in the charging problem, which is addressed as follows. Firstly, the target system AAA server computes the charge claimed by the target system provider based on the use time and the usage and informs the AAA server 150 of the computed charge. Secondly, the target system AAA server computes the use time and the usage and informs the AAA server 150 of the use time and the usage, and the AAA server 150 calculates the charge to be paid to the target system provider.

According to exemplary embodiments of the present invention, the charging rule may be the same as or different from the CS rule. An entity for forwarding the charging rule may be the policy function similar to the CS rule, or a SIM card embedded in the terminal. A component of the ASN can mange the CS rule in the DL, and the terminal can manage the CS rule in the UL. Yet, the management entity of the charging rule relies on whether the statistically collecting entity is the ASN or the terminal. As for the ASN, the elements of the ASN manage the charging in both of the DL and the UL. As for the terminal, the terminal manages the charging in both of the DL and the UL.

Although they are not illustrated in FIG. 1, NEs for allocating the IP address may include, for example, a Dynamic Host Configuration Protocol (DHCP) for a simple IP, and a Home Agent (HA) and a Foreign Agent (FA) for a mobile IP. A Domain Name Server (DNS) for managing the mapping relation of Network Access Identifier (NAI) and the IP addresses is also provided, though is not illustrated in FIG. 1.

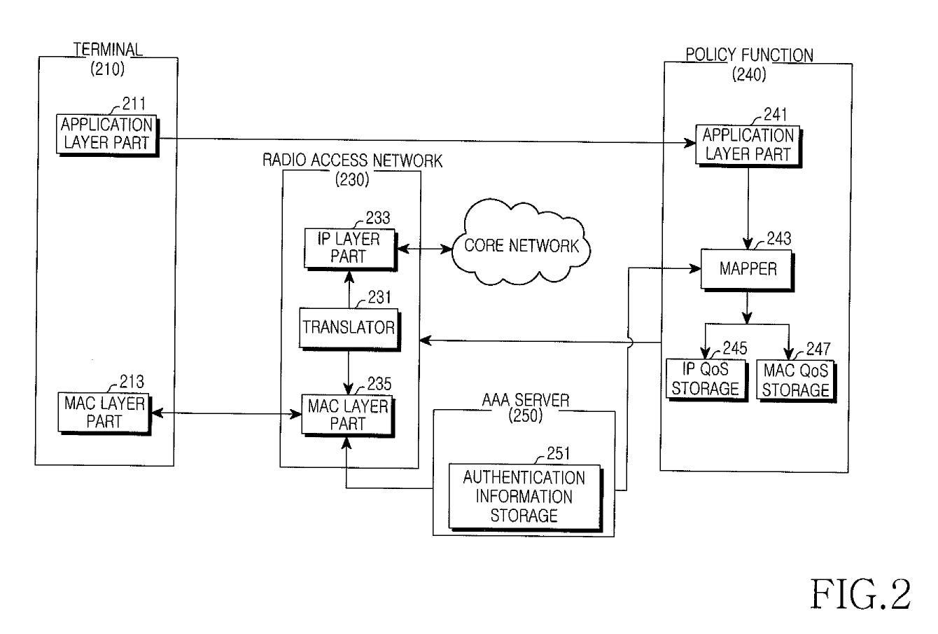

FIG. 2 is a functional structure of NEs in a communication network according to an exemplary embodiment of the present invention. In FIG. 2, a radio access network 230 covers the base station 120 and the ASN_GW 130 of FIG. 1.

Referring to FIG. 2, a terminal 210 includes an application layer part 211 and a MAC layer part 213. The radio access network 230 includes a translator 231, an IP layer part 233, and a MAC layer part 235. A policy function 240 includes an application layer part 241, a mapper 243, an IP QoS storage 245, and a MAC QoS storage 247. An AAA server 250 includes an authentication information storage 251.

An exemplary QoS interworking management method will now be explained with reference to FIG. 2. The application layer part 241 of the policy function 240 obtains QoS information of the application layer transmitted from the application layer part 211 of the terminal 210. The application layer part 241 of the policy function 240 may directly receive the QoS information of the application, or the QoS information of the application layer, which is received at the IMS server or another web server, may be forwarded to the application layer part 241. The mapper 243 of the policy function 240 generates QoS parameters of the IP layer and the MAC layer using the QoS information of the application layer. The IP QoS storage 245 and the MAC QoS storage 247 store the QoS parameters of the respective layers. The mapper 243 receives the authentication information from the authentication information storage 251 of the AAA server 250 and refers to the service level allowed to the terminal 210.

The QoS parameters of the IP layer and the MAC layer, which are generated at the policy function 240, are provided to the terminal 210. The MAC layer part 213 of the terminal 210 manages the MAC layer part 235 of the radio access network 230 and the QoS of the MAC layer using the QoS parameters of the MAC layer. The terminal 210 provides the QoS parameters of the IP layer to the radio access network 230. The IP layer part 233 of the radio access network 230 manages a core network and the QoS of the IP layer according to the QoS parameters of the IP layer.

In conclusion, the terminal 210 ensures the QoS of the IP layer and the QoS of the MAC layer by providing the QoS information of the application layer to the policy function 240.

In the QoS interworking process as discussed above with reference to FIGS. 1 and 2, the policy function is positioned in the core network. According to various exemplary embodiments of the present invention, the policy function may be disposed in the terminal. Also, the policy function can be divided into multiple parts and positioned in the core network and the radio access network respectively. Hereafter, the interworking of the NEs is described in detail by referring to the drawing.

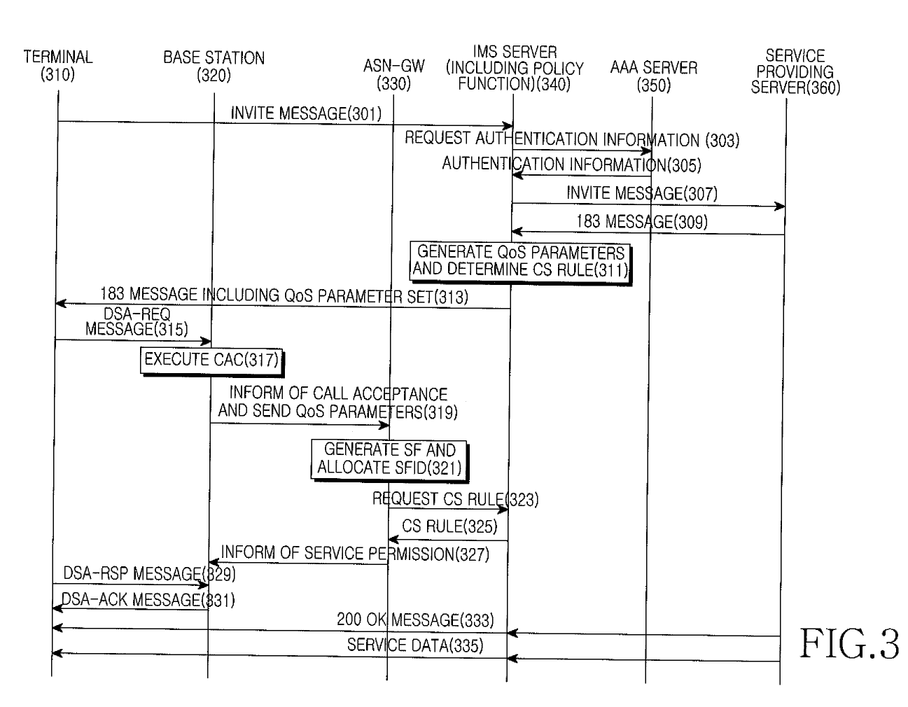

FIG. 3 illustrates a signal exchange between NEs in a communication network according to one exemplary embodiment of the present invention. Particularly, FIG. 3 depicts a signal exchange when the policy function is included to the IMS server of the core network and the terminal initiates the SF generation procedure.

Referring to FIG. 3, a terminal 310 transmits a service request message of the application layer. That is, the terminal 310 transmits an INVITE message of the SIP to the IMS server 340 in step 301. Herein, the service request message includes QoS information of the application layer. For example, QoS information contained in the service request message is shown in Table 1.

TABLE 1

| Type of information | Examples |
|---|---|
| Media type | Audio/video, port number, real-time or not |
| Media attribute | Codec information |
| Connection data information | IPv4/IPv6, network address |
| Bandwidth information | Required data rate |
| | (high quality or low quality) |

To transmit the INVITE message, the terminal 310 should know an IP address of the IMS server 340. The terminal 310 can acquire the IP address of the IMS server 340 in several ways. For example, a terminal manufacturer may store the IP address of the IMS server 340 to the terminal 310 in advance, a terminal user may input the IP address of the IMS server 340, a DHCP server may inform of the IP address in the process of the IP address allocation of the terminal 310, or the terminal 310 may obtain the IP address by separately interworking with the IMS server 340.

Upon receiving the INVITE message, the IMS server 340 requests authentication information of the terminal 310 to the AAA server 350 in step 303.

Receiving the request, the AAA server 350 sends the authentication information of the terminal 310 to the IMS server 340 in step 305. For example, the authentication information may include user class information of the terminal 310. Herein, the user class is determined according to the service policy, and may include for example, premium, gold, silver, and bronze.

The IMS server 340 confirms that the terminal 310 is eligible to receive the service and forwards the service request message. That is, the IMS server 340 forwards the INVITE message of the SIP to the service providing server 360 in step 307. In doing so, if the terminal 310 transmitted the message by using an identifier other than the IP address as the destination information, the IMS server 340 forwards the INVITE message after acquiring the IP address of the service providing server 360 by interworking with the DNS.

The service providing server 360, receiving the INVITE message, transmits a response message for the INVITE message. That is, the service providing server 360 transmits a 183 message of the SIP in step 309.

In step 311, the IMS server 350 generates a QoS parameter set for the SF requested by the terminal 310 based on the QoS information of the application layer in the service request message and the authentication information, and determines a CS rule and a charging rule. Herein, the QoS parameter set includes QoS parameters of the MAC layer and QoS parameters of the IP layer. For example, the QoS parameter set includes parameters of Table 2 and Table 3. Table 2 shows the QoS parameters of the MAC layer as described by the IEEE 802.16 specification, and Table 3 shows exemplary QoS parameters of the present invention.

TABLE 2

| Parameters | Description |
|---|---|
| SFID | Service flow identifier |
| Traffic Priority | Service priority when QoS parameters are the same |
| Maximum Sustained Traffic Rate | Allowed maximum traffic rate of SDU |
| Maximum Traffic Burst | Maximum data amount transmittable at one time |
| Minimum Reserved Traffic Rate | Minimum reserved traffic rate of SDU |
| Maximum Latency | Maximum delay time from CS to radio transmission |
| Tolerated Jitter | Allowed Maximum value of delay time change |
| Uplink Grant Scheduling Type | UL polling service type |
| Unsolicited Grant Interval | Grant time interval in UL UGS |
| Unsolicited Polling Interval | Polling time interval in UL rtPS |
| SDU Size | Used only at a fixed size |
| Time Base | Unit time for traffic rate measurement |

TABLE 3

| Parameters | Description |
|---|---|
| Whether IP header is compressed and | 1. non-compression |
| compression scheme | 2. PHS (Payload Header Suppression) |
| | 3. ROHC (RObust Header Compression) |
| Whether to use TEK (Traffic | |
| Encryption Key) | |
| Whether to allow to change QoS | Corresponds to DSC or IEEE 802.16 specification |
| profile or not | |
| Maximum number of times for | |
| allowing to change QoS profile per SF | |
| How to process QoS parameters not | 1. reuse the previous values |
| exchanged through DSC | 2. use initial values of system |
| | 3. not support relevant QoS parameters |
| Whether to allow to change provision | Provision SF has SFID but no traffic |
| SF of active SF using DSC | |
| Whether to allow state switch timer | Lower priority than the existing idle timer an the |
| from active to provision | existing sleep timer |
| State switch timer value from active to | |
| provision per SF | |
| Reliability | Target Error Rate |
| Call forcible release condition | Sustained time threshold when minimum data rate |
| | is not satisfied |
| Whether to perform ARQ (Automatic | |
| Repeat reQuest) | |
| Whether to provide symmetric service | In bidirectional service request, such as VoIP, with |
| | terminal of relatively low service level, whether to |
| | temporarily increase service level of correspondent |
| | terminal to its level at its own charging |
| Whether to hand over to other provider | |
| network of the same radio technique | |
| Whether hand over to other radio | |
| network of different radio technique | |
| How to process initial access request | 1. force lowest-priority terminal of accessed |
| which exceeds limited number of | awaked terminals to enter sleep mode or idle mode |
| awaken terminals | 2. permit initial access in idle mode |
| | 3. permit initial access in sleep mode, whereas |
| | permit initial access in idle mode when the limited |
| | number of sleeping terminals is exceeded |

The QoS parameters are set for the requested SF as shown in Table 2 and Table 3. Even for a single SF, the set QoS parameters can be distinguished from one another according to their data type. For example, there can be data which must not be lost because of its considerable importance, among various data transmitted and received in one SF. In this case, it is necessary to guarantee the QoS of the data not to be lost at a higher level. For doing so, the differentiation of the QoS parameters is required based on the data type. For instance, for the data of higher significance, the greater number of retransmission times is allocated.

In step 313, the IMS server 340 transmits the 183 message including the QoS parameter set to the terminal 310. The IMS server 340 may transmit the QoS parameter set using a separate application layer message. The application layer message can include at least one of the CS rule and the charging rule.

Upon receiving the QoS parameter set, the terminal 310 commences a Dynamic Service Addition (DSA). In more detail, the terminal 310 transmits a DSA-REQ message to the base station 320 in step 315. The DSA-REQ message includes the QoS parameter set. When the QoS parameters are differentiated based on the data type, the DSA-REQ message includes per-type QoS parameter information generated as an array. To distinguish the service between the terminal 310 and the ASN_GW 330, a name tag is needed. Hence, the terminal 310 performs the DSA by generating and using a specific name tag per SF. For example, the name tag can employ a PRovisioning instance ID (PRID) which identifies an instance of the policy class.

The base station 320, receiving the DSA-REQ message, confirms the QoS parameters of the MAC layer in the DSA-REQ message and performs a Call Admission Control (CAC) based on the QoS parameters of the MAC layer in step 317.

When the call is accepted as a result of the CAC, the base station 320 informs the ASN_GW 330 of the call acceptance and transmits the QoS parameters of the IP layer in step 319. That is, the base station 320 informs the ASN_GW 330 that the extra resource for the terminal 310 is ensured.

Being informed of the call acceptance and receiving the QoS parameters, the ASN_GW 330 determines whether to allow the requested service. In the example illustrated in FIG. 3, it is assumed that the service is permitted. Accordingly, the ASN_GW 330 generates a SF for the service and allocates a SF ID in step 321. The ASN_GW 330 determines whether to allow the service as follows.

Firstly, the ASN_GW 330 determines whether to permit the service depending on the call acceptance of the base station 320. When the base station 320 accepts the call, the ASN_GW 330 permits the service. Secondly, the ASN_GW 330 makes a determination by acquiring QoS permitted range information of the corresponding terminal. Thirdly, the ASN_GW 330 entrusts the determination to the policy function. More specifically, the ASN_GW 330 provides the obtained QoS parameters to the policy function and follows the determination of the policy function. As informing of the determination, the policy function can inform the ASN_GW 330 of at least one of the QoS information and the charging rule required.

Alternatively, the ASN_GW 330 needs to obtain the QoS permitted range information. The ASN_GW 330 can obtain the QoS permitted range information from the AAA server 350 or the policy function. When the AAA server 350 provides the QoS permitted range information, the ASN_GW 330 obtains the QoS permitted range information from the AAA server 350 after the authentication of steps 303 and 305. When the PDF provides the QoS permitted range information, the ASN_GW 330 acquires the QoS permitted range information from the PDF in an IP can session process performed when the corresponding terminal enters the network, or acquires the QoS permitted range information from the PDF at every service request.

After permitting the service using one of the above-mentioned methods, the ASN_GW 330 transmits a request for CS rule information to the IMS server 340 in step 323. The IMS server 340 sends the CS rule information to the ASN_GW 330 in step 325. The 183 message may carry the CS rule together with the QoS parameter set in step 313. In this case, the CS rule is forwarded to the ASN_GW 330 in step 319. Hence, steps 323 and 325 are omitted. However, the system operator can make the ASN_GW 330 repeatedly acquire the CS rule by conducting steps 323 and 325 at the operator's discretion.

In step 327, the ASN_GW 330 informs the base station 320 of the service permission. The base station 320 sends a DSA-RSP message to the terminal 310 in step 329. The terminal 310 sends a DSA-ACK message to the base station 320 in step 331.

Next, the service providing server 360 transmits a service process inform message. That is, the service providing server 360 transmits a 200 OK message of the SIP to the terminal 310 in step 333 and then transmits service data in step 335.

Of the NEs in FIG. 3, the IMS server 340 includes the policy function and generates a session using the SIP. In an exemplary implementation, the IMS server 340 can be replaced by a web server which performs the same function using an HTTP. Alternatively, the IMS server 340 can be split to one server including a Serving-CSCF (S-CSCF) function and an Interrogating-CSCF (I-CSCF) function, and the other server including the P-CSCF and the PDF. Furthermore, the policy function may be an independent device. In this situation, the IMS server 340 or the web server provides the input variables to the independent policy function device, and the policy function device provides the QoS parameter set to the terminal 310. The policy function can be divided to the PCRF and the PDF. The PCRF generates the QoS parameters of the IP layer using the QoS parameters of the application layer, and the PDF generates the parameters of the radio access network. That is, the PDF generates the QoS parameters of the MAC layer using the QoS parameters of the IP layer.

When the policy function is present in the core network as illustrated in FIG. 3, the policy function can provide the information for determining whether to permit the service. That is, the policy function can provide the QoS parameter set and the QoS permitted range information directly to the ASN_GW. The base station may not forward the QoS parameters received from the terminal to the ASN_GW. However, the ASN_GW does not know whether to make the base station perform the DSA or whether to allow the service using the QoS parameter set. Accordingly, as transmitting the QoS parameter set and the QoS permitted range information, the policy function also transmits a parameter indicative of the usage of the QoS parameters. That is, the policy function also transmits a parameter indicative of the DSA triggering or the service permission.

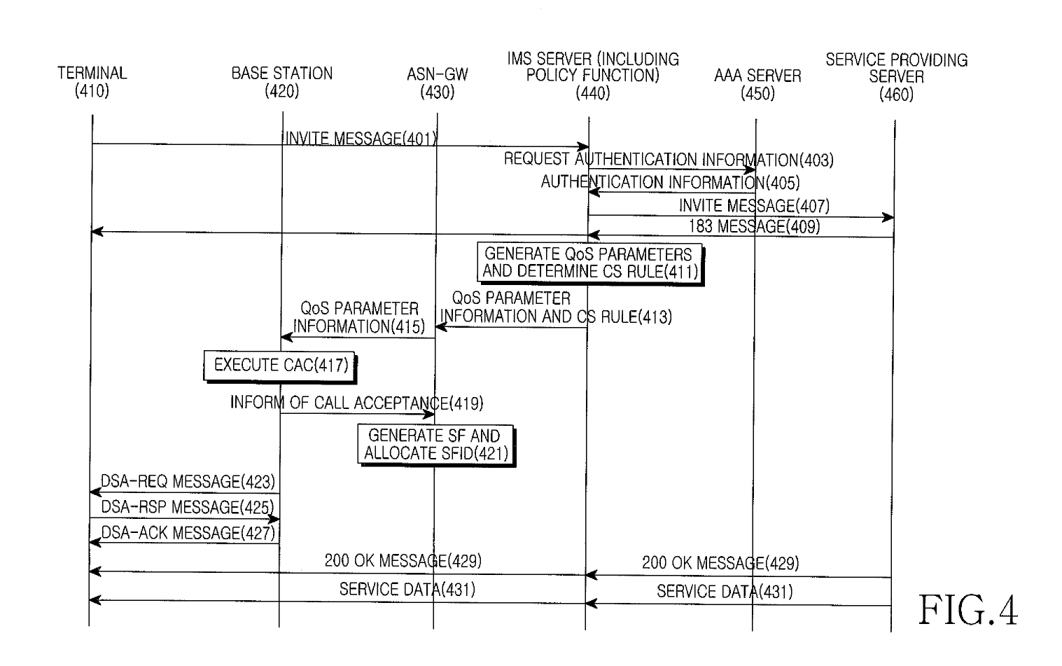

FIG. 4 is a signal exchange diagram between NEs in a communication network according to another exemplary embodiment of the present invention. In FIG. 4, a policy function is included in an IMS server of a core network and a base station commences an SF generation process.

Referring to FIG. 4, a terminal 410 transmits a service request message of the application layer in step 401. That is, the terminal 410 transmits an INVITE message of the SIP to the IMS server 440. The service request message includes QoS information of the application layer. For example, the QoS information in the service request message as shown in Table 1.

To transmit the INVITE message, the terminal 410 should know an IP address of the IMS server 440. The terminal 410 may acquires the IP address of the IMS server 440 in several ways. For example, the terminal manufacturer may store the IP address of the IMS server 440 to the terminal 410 in advance, the terminal user may input the IP address of the IMS server 440, the DHCP server may inform of the IP address in the process of the IP address allocation of the terminal 410, or the terminal 410 may acquire the IP address by separately interworking with the IMS server 440.

In step 403, the IMS server 440 receiving the INVITE message requests authentication information of the terminal 410 to the AAA server 450.

The AAA server 450 transmits the authentication information of the terminal 410 to the IMS server 440 in step 405. For example, the authentication information can be user class information of the terminal 410. The user class, which is determined by the service policy, can include premium, gold, silver, and bronze levels.

Upon receiving the authentication information, the IMS server 440 confirms that the terminal 410 is eligible to receive the service, and forwards the service request message. That is, the IMS server 440 forwards the INVITE message of the SIP to the service providing server 460 in step 407. In doing so, when the terminal 410 transmitted the message by including destination information as an identifier other than the IP address, the IMS server 440 acquires the IP address of the service providing server 460 by interworking with the DNS and then forwards the INVITE message.

The service providing server 460, receiving the INVITE message, transmits a response message for the INVITE message. That is, the service providing server 460 transmits a 183 message of the SIP in step 409.

Based on the QoS information of the application layer in the service request message and the authentication information, the IMS server 440 generates a QoS parameter set for the SF requested by the terminal 410 and determines the CS rule and the charging rule in step 411. The QoS parameter set includes the QoS parameters of the MAC layer and the QoS parameters of the IP layer. For example, the QoS parameter set includes the parameters of Table 2 and Table 3. Table 2 shows the QoS parameters of the MAC layer as described in the IEEE 802.16 specification and Table 3 shows the QoS parameters of the present invention.

Next, the IMS server 440 transmits the QoS parameter information and the CS rule to the ASN_GW 430 in step 413. To distinguish the service between the IMS server 440 and the ASN_GW 430, a name tag is needed. Hence, to transmit the QoS parameter information, the IMS server 440 generates and utilizes specific name tags on the SF basis. For example, the name tag can employ a PRID which identifies the instance of the policy class.

Receiving the QoS parameter information, the ASN_GW 430 triggers the DSA and sends the QoS parameter information of the MAC layer required for the DSA, to the base station 420 in step 415.

The base station 420 confirms the QoS parameters of the MAC layer received from the ASN_GW 430 and conducts the CAC using the QoS parameters of the MAC layer in step 417.

When the call is accepted as a result of the CAC, the base station 420 informs the ASN_GW 430 of the call acceptance in step 419. In other words, the base station 420 informs the ASN_GW 430 that the extra resource for the terminal 410 is ensured.

In step 421, the ASN_GW 430 generates an SF for the requested service and allocates an SF ID.

After allocating a TCID to the terminal 410, the base station 420 sends a DSA-REQ message including the QoS parameters of the MAC layer using the TCID in step 423.

After receiving and confirming the DSA-REQ message, the terminal 410 establishes the connection by opening a physical port and generating traffic interfaces between the layers and then sends a DSA-RSP message to the base station 420 in step 425.

The base station 420, receiving the DSA-RSP message, sends a DSA-ACK message to the terminal 410 in step 427.

The service providing server 460 transmits a service process inform message; that is, a 200 OK message of the SIP to the terminal 410 in step 429 and transmits service data in step 431.

Of the NEs in FIG. 4, the IMS server 440 includes the policy function and generates a session using the SIP. Herein, the IMS server 440 can be replaced by a web server which performs the same function using the HTTP. Alternatively, the IMS server 440 can be split into one server including an S-CSCF and an I-CSCF, and the other server including the P-CSCF and the policy function. Furthermore, the policy function may be an independent device. In this situation, the IMS server 440 or the web server provides the input variables to the independent policy function device, and the policy function device provides the QoS parameter set to the base station 420. The policy function can be divided into the PCRF and the PDF. The PCRF generates the QoS parameters of the IP layer using the QoS parameters of the application layer, and the PDF generates the QoS parameters of the radio access network. That is, the PDF generates the QoS parameters of the MAC layer using the QoS parameters of the IP layer.

When the policy function is present in the core network as illustrated in FIG. 4, the policy function may provide the information for determining whether to permit the service. That is, the policy function may provide the QoS parameter set and the QoS permitted range information directly to the ASN_GW. The base station may not forward the QoS parameters received from the terminal, to the ASN_GW. However, the ASN_GW does not know whether to make the base station perform the DSA or whether to determine the service using the QoS parameter set. Accordingly, as transmitting the QoS parameter set and the QoS permitted range information, the policy function also transmits a parameter indicative of the usage of the QoS parameters. That is, the policy function also transmits a parameter for the DSA triggering or the service permission.

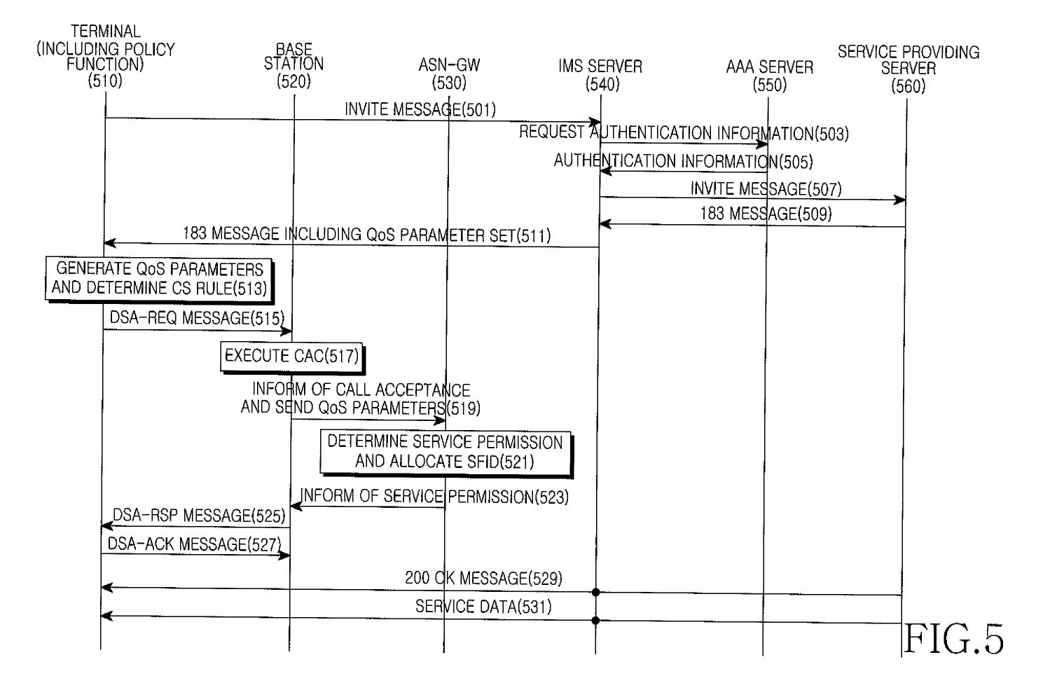

FIG. 5 is a signal exchange diagram between NEs in a communication network according to yet another exemplary embodiment of the present invention. In FIG. 5, the terminal includes the policy function and commences an SF generation process.

Referring to FIG. 5, a terminal 510 transmits a service request message of the application layer. That is, the terminal 510 transmits an INVITE message of the SIP to the IMS server 540 in step 501. The service request message includes QoS information of the application layer. For example, the QoS information delivered by the service request message is shown in Table 1.

To send the INVITE message, the terminal 510 should know an IP address of the IMS server 540. The terminal 510 may acquire the IP address of the IMS server 540 in several ways. For example, the terminal manufacturer may store the IP address of the IMS server 540 to the terminal 510 in advance, the terminal user may input the IP address of the IMS server 540, the DHCP server may inform of the IP address in the process of the IP address allocation of the terminal 510, or the IP address may be acquired through the separate interworking between the terminal 510 and the IMS server 540.

Upon receiving the INVITE message, the IMS server 540 requests authentication information of the terminal 510 to the AAA server 550 in step 503.

The AAA server 550 transmits the authentication information of the terminal 510 to the IMS server 540 in step 505. For example, the authentication information can be user class information of the terminal 510. The user class, which is determined by the service policy, can include for example, premium, gold, silver, and bronze.

Upon receiving the authentication information, the IMS server 540 confirms that the terminal 510 is eligible to receive the service, and forwards the service request message. That is, the IMS server 540 forwards the INVITE message of the SIP to the service providing server 560 in step 507. In doing so, when the terminal 510 transmitted the message by including destination information as an identifier other than the IP address, the IMS server 540 acquires the IP address of the service providing server 560 by interworking with the DNS and then forwards the INVITE message.

The service providing server 560, receiving the INVITE message, transmits a response message for the INVITE message. That is, the service providing server 560 transmits a 183 message of the SIP in step 509.

In step 511, the IMS server 540 forwards the 183 message including the authentication information to the terminal 510. The IMS server 540 may transmit the authentication information using a separate application layer message.

The terminal 510 generates a QoS parameter set for the requested service based on the QoS information of the application layer and the authentication information, and determines a CS rule and a charging rule in step 513. For example, the QoS parameter set includes the parameters of Table 2 and Table 3. The information in Table 2 is the QoS parameters of the MAC layer as described in the IEEE 802.16 specification, and the information in Table 3 is the QoS parameters of the present invention. For the requested SF, the QoS parameters are defined as shown in Table 2 and Table 3. Even for a single SF, the defined QoS parameters can be distinguished from one another based on the data type.

Next, the terminal 510 commences the DSA. More specifically, the terminal 510 sends a DSA-REQ message to the base station 520 in step 515. The DSA-REQ message includes at least one of the QoS parameter set, the CS rule, and the charging rule. When the QoS parameters are differentiated based on the data type, the DSA-REQ message includes the type-based QoS parameter information constituted as an array. At this time, to distinguish the service between the terminal 510 and the ASN_GW 530, a name tag is needed. The terminal 510 generates and utilizes specific name tags on the SF basis to conduct the DSA. For example, the name tag can be PRID which identifies the instance of the policy class.

The base station 520, upon receiving the DSA-REQ message, confirms the QoS parameters of the MAC layer in the DSA-REQ message, from the ASN_GW 530 and then performs the CAC based on the QoS parameters of the MAC layer in step 517.

When the call is accepted as a result of the CAC, the base station 520 informs the ASN_GW 530 of the call acceptance and transmits the QoS parameters of the IP layer and the CS rule in step 519. That is, the base station 520 informs the ASN_GW 530 that the extra resource for the terminal 510 is ensured.

The ASN_GW 530 determines whether to permit the requested service. In the example illustrated in FIG. 5, it is assumed the service is allowed. The ASN_GW 530 generates a SF for the service and allocates a SF ID in step 521. The ASN_GW 530 determines whether to permit the service as follows.

Firstly, the ASN_GW 530 determines to permit the service depending on the call acceptance by the base station 520. When the base station 520 accepts the call, the ASN_GW 530 permits the service. Secondly, the ASN_GW 530 makes a determination by acquiring QoS permitted range information of the corresponding terminal. Thirdly, the ASN_GW 530 entrusts the determination to the policy function. More specifically, the ASN_GW 530 provides the obtained QoS parameters to the policy function and follows the determination of the policy function. As informing of the determination result, the policy function can inform the ASN_GW 530 of at least one of the QoS information and the charging rule required.

Alternatively, the ASN_GW 530 needs to obtain the QoS permitted range information. The ASN_GW 530 can obtain the QoS permitted range information from the AAA server 550 or the policy function. When the AAA server 550 provides the QoS permitted range information, the ASN_GW 530 obtains the QoS permitted range information from the AAA server 550 after the authentication of steps 503 and 505. When the policy function provides the QoS permitted range information, the ASN_GW 530 acquires the QoS permitted range information from the policy function in an IP can session process performed when the corresponding terminal enters the network, or acquires the QoS permitted range information from the PDF at every service request.

After allowing the service using one of the above-mentioned methods, the ASN_GW 530 informs the base station 520 of the service permission in step 523. The base station 520 sends a DSA-RSP message to the terminal 510 in step 525, and the terminal 510 sends a DSA-ACK message to the base station 520 in step 527.

Next, the service providing server 560 transmits a service process inform message. That is, the service providing server 560 transmits a 200 OK message of the SIP to the terminal 510 in step 529 and then transmits service data in step 531.

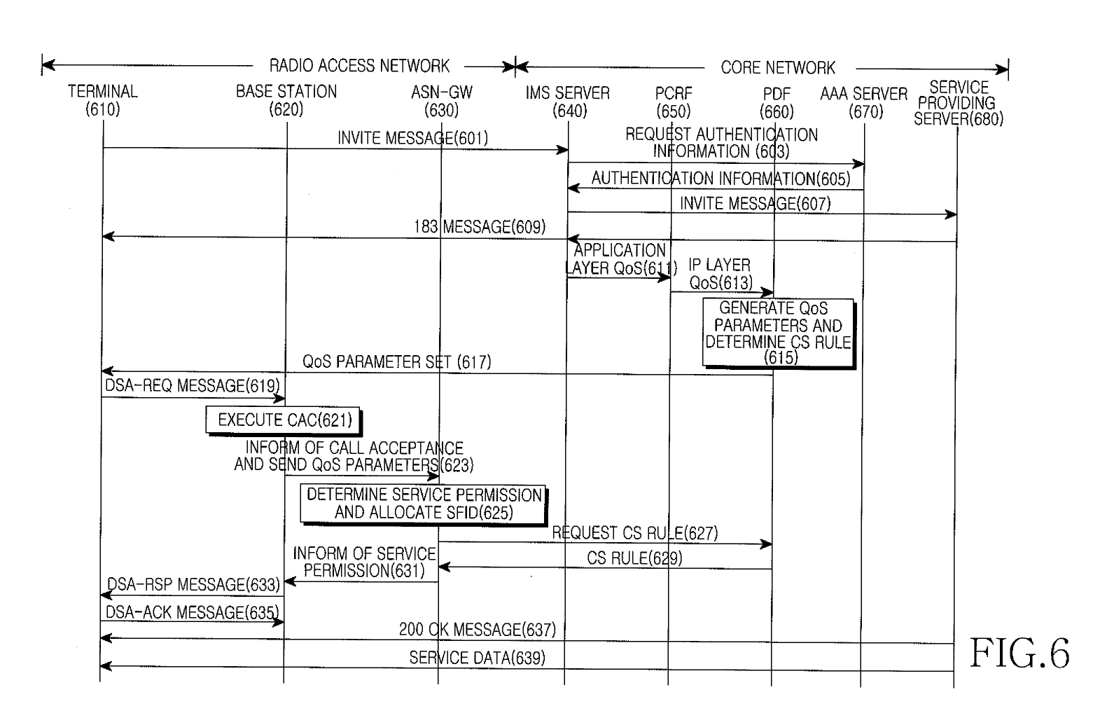

FIG. 6 is a signal exchange between NEs in a communication network according to still another exemplary embodiment of the present invention. In FIG. 6, the policy function is divided to the PCRF and the PDF and is present in the core network independently.

Referring to FIG. 6, a terminal 610 transmits a service request message of the application layer in step 601. That is, the terminal 610 transmits an INVITE message of the SIP to the IMS server 640. The service request message includes QoS information of the application layer. For example, the QoS information carried in the service request message is shown in Table 1.

To send the INVITE message, the terminal 610 should know an IP address of the IMS server 640. The terminal 610 can acquire the IP address of the IMS server 640 in several ways. For instance, the terminal manufacturer may store the IP address of the IMS server 640 to the terminal 610 in advance, the terminal user may input the IP address of the IMS server 640, the DHCP server may inform of the IP address in the process of the IP address allocation of the terminal 610, or the IP address may be acquired through the separate interworking between the terminal 610 and the IMS server 640.

Upon receiving the INVITE message, the IMS server 640 transmits a request for authentication information of the terminal 610 to the AAA server 670 in step 603.

The AAA server 670 transmits the authentication information of the terminal 610 to the IMS server 640 in step 605. For example, the authentication information can be user class information of the terminal 610. The user class, which is determined by the service policy, can include for example premium, gold, silver, and bronze.

Upon receiving the authentication information, the IMS server 640 confirms that the terminal 610 is eligible to receive the service, and forwards the service request message. That is, the IMS server 640 forwards the INVITE message of the SIP to the service providing server 680 in step 607. In doing so, when the terminal 610 transmitted the message by including destination information as an identifier other than the IP address, the IMS server 640 acquires the IP address of the service providing server 680 by interworking with the DNS and then forwards the INVITE message.

The service providing server 680, receiving the INVITE message, transmits a response message for the INVITE message. That is, the service providing server 680 transmits a 183 message of the SIP to the IMS server 640, and the IMS server 640 forwards the 183 message of the SIP to the terminal 610 in step 609.

The IMS server 640 receiving the 183 message of the SIP transmits the QoS parameters of the application layer to the PCRF 650 in step 611.

The PCRF 650 generates QoS parameters of the IP layer using the received QoS parameters of the application layer. In more detail, the PCRF 650 determines QoS parameters to be guaranteed in the IP layer so as to meet the QoS parameters of the application layer and sends the QoS parameters of the IP layer to the PDF 660 in step 613.

The PDF 660 generates a QoS parameter set for the SF requested by the terminal 610 using the received QoS parameters of the IP layer, and determines a CS rule and a charging rule in step 615. The QoS parameter set includes the QoS parameters of the MAC layer and the QoS parameters of the IP layer. For example, the QoS parameter set includes the parameters of Table 2 and Table 3. Table 2 shows the QoS parameters of the MAC layer as described in the IEEE 802.16 specification and Table 3 shows the QoS parameters of the present invention. For the requested SF, the QoS parameters of Table 2 and Table 3 are defined. Even for a single SF, the set QoS parameters can be distinguished from one another based on the data type. Among various data transmitted and received in the SF, there can be data which must not be lost because of its considerable importance. It is necessary to guarantee the QoS of the data not to be lost at a higher level. For doing so, the differentiation of the QoS parameters is required based on the data type. For instance, for the higher data significance, the greater number of retransmission times is set.

In step 617, the PDF 660 transmits the QoS parameter set to the terminal 610. At least one of the CS rule and the charging rule can be additionally transmitted.

When receiving the QoS parameter set, the terminal 610 commences the DSA. That is, the terminal 610 sends a DSA-REQ message to the base station 620 in step 619. The DSA-REQ message includes the QoS parameter set. When the QoS parameters are differentiated based on the data type, the DSA-REQ message includes the type-based QoS parameter information constituted as an array. At this time, a name tag is needed to distinguish the service between the terminal 610 and the ASN_GW 630. The terminal 610 performs the DSA by generating and using a specific name tag per SF. For example, the name tag can utilize PRID which identifies the instance of the policy class.

The base station 620, receiving the DSA-REQ message, confirms the QoS parameters of the MAC layer in the DSA-REQ message, from the ASN_GW 630 and conducts the CAC based on the QoS parameters of the MAC layer in step 621.

When the call is accepted as a result of the CAC, the base station 620 informs the ASN_GW 630 of the call acceptance and sends the QoS parameters of the IP layer in step 623. Namely, the base station 620 informs the ASN_GW 630 that the extra resource for the terminal 610 is ensured.

The ASN_GW 630 determines whether to permit the requested service. It is assumed the service is allowed. The ASN_GW 630 generates an SF for the service and allocates an SF ID in step 625. The ASN_GW 630 determines whether to permit the service as follows.

Firstly, the ASN_GW 630 determines whether to permit the service depending on the call acceptance by the base station 620. When the base station 620 accepts the call, the ASN_GW 630 permits the service. Secondly, the ASN_GW 630 makes a determination by acquiring QoS permitted range information of the corresponding terminal. Thirdly, the ASN_GW 630 entrusts the determination to the PDF 660. More specifically, the ASN_GW 630 provides the obtained QoS parameters to the PDF 660 and follows the determination of the PDF 660. As informing of the determination result, the PDF 660 can inform the ASN_GW 630 of at least one of the QoS information and the charging rule required.

Alternatively, the ASN_GW 630 needs to obtain the QoS permitted range information. The ASN_GW 630 can obtain the QoS permitted range information from the AAA server 670 or the PDF 660. When the AAA server 670 provides the QoS permitted range information, the ASN_GW 630 obtains the QoS permitted range information from the AAA server 670 after the authentication of steps 603 and 605. When the PDF 660 provides the QoS permitted range information, the ASN_GW 630 acquires the QoS permitted range information from the PDF 660 in an IP can session process performed when the corresponding terminal enters the network, or acquires the QoS permitted range information from the PDF 660 at every service request.

After permitting the service using one of the above-mentioned methods, the ASN_GW 630 transmits a request for CS rule information to the PDF 660 in step 627. The PDF 660 transmits the CS rule information to the ASN_GW 630 in step 629. The CS rule may be transmitted together with the QoS parameter set using the 183 message in step 617. In this situation, the CS rule is forwarded to the ASN_GW 630 in step 623. Accordingly, steps 327 and 329 are omitted. However, the system operator can make the ASN_GW 630 repeatedly acquire the CS rule information in steps 627 and 629 at the operator's discretion.

In step 631, the ASN_GW 630 informs the base station 620 of the service permission. The base station 620 sends a DSA-RSP message to the terminal 610 in step 633. The terminal 610 sends a DSA-ACK message to the base station 620 in step 635.

The service providing server 680 sends a service process inform message. That is, the service providing server 680 sends a 200 OK message of the SIP to the terminal 610 in step 637 and transmits service data in step 639.

Of the NEs in FIG. 6, the IMS server 640 generates the session using the SIP. In an exemplary implementation, the IMS server 640 can be replaced by a web server which executes the same function using the HTTP. Alternatively, the IMS server 640 can be divided to one server including the S-CSCF and the I-CSCF and the other server including the P-CSCF.

The PDF 660 of FIG. 6 outputs the QoS parameter set of the radio access network. In various exemplary embodiments of the present invention, the PDF 660 outputs the QoS parameter set of the radio access network, or outputs the QoS parameters of the IP layer generated by the PCRF 650 and at least one of its generated QoS parameters of the IP layer. In the latter case, the output information of the PDF 660 is determined under the control of the PCRF 650. More specifically, the PCRF 650 transmits a control bit for determining the output information of the PDF 660. According to the control bit, the PDF 660 outputs the QoS parameter set of the radio access network, or selectively outputs the QoS parameters of the IP layer generated by the PCRF 650 and at least one of its generated QoS parameters of the IP layer.

While the terminal commences the DSA in FIG. 6, the base station can commence the DSA process. In this case, the QoS parameter set of the radio access network is generated as in FIG. 6.

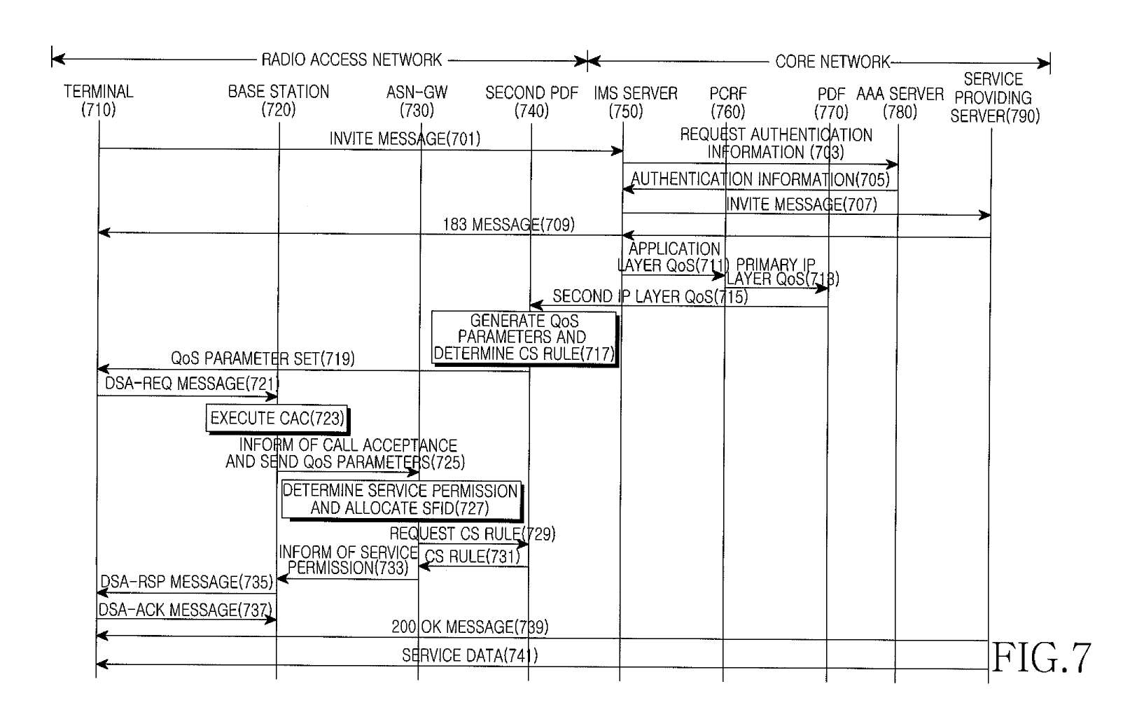

FIG. 7 is a signal exchange diagram between NEs in a communication network according to a further exemplary embodiment of the present invention. In FIG. 7, the policy function is divided to the PCRF and the PDF and the PDF is present in the core network and in the radio access network separately.

Referring to FIG. 7, a terminal 710 transmits a service request message of the application layer in step 701. That is, the terminal 710 transmits an INVITE message of the SIP to the IMS server 750. The service request message includes QoS information of the application layer. For example, the QoS information carried in the service request message is shown in Table 1.

To send the INVITE message, the terminal 710 should know an IP address of the IMS server 750. The terminal 710 can acquire the IP address of the IMS server 750 in several ways. For example, the terminal manufacturer may store the IP address of the IMS server 750 to the terminal 710 in advance, the terminal user may input the IP address of the IMS server 750, the DHCP server may inform of the IP address in the process of the IP address allocation of the terminal 710, or the IP address may be acquired through the separate interworking between the terminal 710 and the IMS server 750.

Upon receiving the INVITE message, the IMS server 750 transmits a request for authentication information of the terminal 710 to the AAA server 780 in step 703.

The AAA server 780 transmits the authentication information of the terminal 710 to the IMS server 750 in step 705. For example, the authentication information can be user class information of the terminal 710. The user class, which is determined by the service policy, can include for example premium, gold, silver, and bronze.

Upon receiving the authentication information, the IMS server 750 confirms that the terminal 710 is eligible to receive the service, and forwards the service request message. That is, the IMS server 750 forwards the INVITE message of the SIP to the service providing server 790 in step 707. In doing so, when the terminal 710 transmitted the message by including destination information as an identifier other than the IP address, the IMS server 750 acquires the IP address of the service providing server 790 by interworking with the DNS and then forwards the INVITE message.

The service providing server 790, receiving the INVITE message, transmits a response message for the INVITE message. That is, the service providing server 790 transmits a 183 message of the SIP to the IMS server 750, and the IMS server 750 forwards the 183 message of the SIP to the terminal 710 in step 709.

The IMS server 750 receiving the 183 message of the SIP transmits the QoS parameters of the application layer to the PCRF 760 in step 711.

The PCRF 760 generates primary QoS parameters of the IP layer using the received QoS parameters of the application layer. In more detail, the PCRF 760 determines QoS parameters to be guaranteed in the IP layer so as to meet the QoS parameters of the application layer. Next, the PCRF 760 sends the primary QoS parameters of the IP layer to the first PDF 770 in step 713.

The first PDF 770 generates secondary QoS parameters of the IP layer by adding additional QoS parameters of the IP layer to the primary QoS parameters of the IP layer. The additional QoS parameters of the IP layer are used in the radio access network and determined based on the characteristic of the radio access network. The first PDF 770 sends the secondary QoS parameters of the IP layer to the second PDF 740 in the radio access network in step 715.

The second PDF 740 generates a QoS parameter set of the radio access network for the SF requested by the terminal 710 using the secondary QoS parameters of the IP layer, and determines the CS rule and the charging rule in step 717. The QoS parameter set of the radio access network includes the QoS parameters of the MAC layer and the QoS parameters of the IP layer. For example, the QoS parameter set of the radio access network includes the parameters of Table 2 and Table 3. Table 2 shows the QoS parameters of the MAC layer as described in the IEEE 802.16 specification and Table 3 shows the QoS parameters of the present invention. For the requested SF, the QoS parameters of Table 2 and Table 3 are defined. Even for a single SF, the set QoS parameters can be distinguished based on their data type. Among various data transmitted and received in the SF, there can be data which must not be lost because of its considerable importance. Since it is necessary to guarantee the QoS of the data not to be lost at a higher level, the differentiation of the QoS parameters is required based on the data type. For instance, for the higher data significance, the greater number of retransmission times is set.

In step 719, the second PDF 740 transmits the QoS parameter set to the terminal 710. At least one of the CS rule and the charging rule can be transmitted together.

When receiving the QoS parameter set, the terminal 710 commences the DSA. That is, the terminal 710 sends a DSA-REQ message to the base station 720 in step 721. The DSA-REQ message includes the QoS parameter set. When the QoS parameters are differentiated based on the data type, the DSA-REQ message includes the type-based QoS parameter information constituted as an array. At this time, a name tag is needed to distinguish the service between the terminal 710 and the ASN_GW 730. The terminal 710 performs the DSA by generating and using a specific name tag per SF. For example, the name tag can utilize PRID which identifies the instance of the policy class.

The base station 720, receiving the DSA-REQ message, confirms the QoS parameters of the MAC layer in the DSA-REQ message, from the ASN_GW 730 and conducts the CAC based on the QoS parameters of the MAC layer in step 723.

When the call is accepted as a result of the CAC, the base station 720 informs the ASN_GW 730 of the call acceptance and sends the QoS parameters of the IP layer in step 725. Namely, the base station 720 informs the ASN_GW 730 that the extra resource for the terminal 710 is ensured.

The ASN_GW 730 determines whether to permit the requested service. In the exemplary implementation of FIG. 7, it is assumed the service is allowed. The ASN_GW 730 generates an SF for the service and allocates an SF ID in step 727. The ASN_GW 730 determines whether to permit the service as follows.

Firstly, the ASN_GW 730 determines whether to permit the service depending on the call acceptance by the base station 720. When the base station 720 accepts the call, the ASN_GW 730 permits the service. Secondly, the ASN_GW 730 makes a determination by acquiring QoS permitted range information of the corresponding terminal. Thirdly, the ASN_GW 730 entrusts the determination to the second PDF 740. More specifically, the ASN_GW 730 provides the obtained QoS parameters to the second PDF 740 and follows the determination of the second PDF 740. As informing of the determination result, the second PDF 740 can inform the ASN_GW 730 of at least one of the QoS information and the charging rule required.

Alternatively, the ASN_GW 730 needs to obtain the QoS permitted range information. The ASN_GW 730 can obtain the QoS permitted range information from the AAA server 780 or the second PDF 740. When the AAA server 780 provides the QoS permitted range information, the ASN_GW 730 obtains the QoS permitted range information from the AAA server 780 after the authentication of steps 703 and 705. When the second PDF 740 provides the QoS permitted range information, the ASN_GW 730 acquires the QoS permitted range information from the second PDF 740 in an IP can session process performed when the corresponding terminal enters the network, or acquires the QoS permitted range information from the second PDF 740 at every service request.

After permitting the service using one of the above-mentioned methods, the ASN_GW 730 transmits a request for CS rule information to the second PDF 740 in step 729. The second PDF 740 transmits the CS rule information to the ASN_GW 730 in step 731. The CS rule may be transmitted together with the QoS parameter set using the 183 message in step 719. At this time, the CS rule is forwarded to the ASN_GW 730 in step 725. Accordingly, steps 729 and 731 are omitted. However, the system operator can make the ASN_GW 730 repeatedly acquire the CS rule information in steps 729 and 731 at the operator's discretion.

In step 733, the ASN_GW 730 informs the base station 720 of the service permission. The base station 720 sends a DSA-RSP message to the terminal 710 in step 735. The terminal 710 sends a DSA-ACK message to the base station 720 in step 737.

The service providing server 790 sends a service process inform message. That is, the service providing server 790 sends a 200 OK message of the SIP to the terminal 710 in step 739 and transmits service data in step 741.

Of the NEs in FIG. 7, the IMS server 750 generates the session using the SIP. The IMS server 750 can be replaced by a web server which executes the same function using the HTTP. Alternatively, the IMS server 750 can be divided to one server including the S-CSCF and the I-CSCF and the other server including the P-CSCF.

While the terminal commences the DSA in FIG. 7, the base station can commence the DSA process. In this case, the QoS parameter set of the radio access network is generated as in FIG. 7.

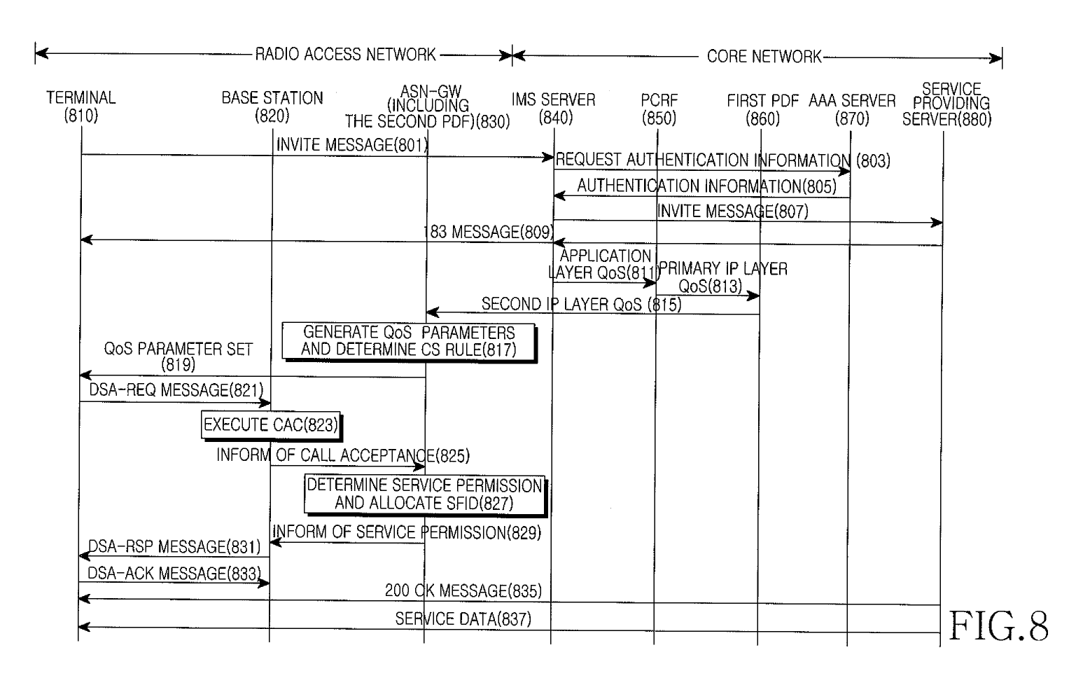

FIG. 8 is a signal exchange diagram between NEs in a communication network according to a further exemplary embodiment of the present invention. In FIG. 8, the policy function is divided to the PCRF and the PDF, the PDF is present in the core network and in the radio access network separately, and the second PDF in the radio access network is included to the ASN_GW.

Referring to FIG. 8, a terminal 810 transmits a service request message of the application layer in step 801. That is, the terminal 810 transmits an INVITE message of the SIP to the IMS server 840. The service request message includes QoS information of the application layer. For example, the QoS information carried in the service request message is shown in Table 1.

To send the INVITE message, the terminal 810 should know an IP address of the IMS server 840. The terminal 810 can acquire the IP address of the IMS server 840 in several ways. For example, the terminal manufacturer may store the IP address of the IMS server 840 to the terminal 810 in advance, the terminal user may input the IP address of the IMS server 840, the DHCP server may inform of the IP address in the process of the IP address allocation of the terminal 810, or the IP address may be acquired through the separate interworking between the terminal 810 and the IMS server 840.

Upon receiving the INVITE message, the IMS server 840 transmits a request for authentication information of the terminal 810 to the AAA server 870 in step 803.

The AAA server 870 transmits the authentication information of the terminal 810 to the IMS server 840 in step 805. For example, the authentication information can be user class information of the terminal 810. The user class, which is determined by the service policy, can include for example premium, gold, silver, and bronze.

Upon receiving the authentication information, the IMS server 840 confirms that the terminal 810 is eligible to receive the service, and forwards the service request message. That is, the IMS server 840 forwards the INVITE message of the SIP to the service providing server 880 in step 807. In doing so, when the terminal 810 transmitted the message by including destination information as an identifier other than the IP address, the IMS server 840 acquires the IP address of the service providing server 880 by interworking with the DNS and then forwards the INVITE message.

The service providing server 880, receiving the INVITE message, transmits a response message for the INVITE message. That is, the service providing server 880 transmits a 183 message of the SIP to the IMS server 840, and the IMS server 840 forwards the 183 message of the SIP to the terminal 810 in step 809.

The IMS server 840 receiving the 183 message of the SIP transmits the QoS parameters of the application layer to the PCRF 850 in step 811.

The PCRF 850 generates primary QoS parameters of the IP layer using the received QoS parameters of the application layer. In more detail, the PCRF 850 determines QoS parameters to be guaranteed in the IP layer so as to meet the QoS parameters of the application layer. Next, the PCRF 850 sends the primary QoS parameters of the IP layer to the first PDF 860 in step 813.

The first PDF 860 generates secondary QoS parameters of the IP layer by adding additional QoS parameters of the IP layer to the primary QoS parameters of the IP layer. The additional QoS parameters of the IP layer are used in the radio access network and determined based on the characteristic of the radio access network. The first PDF 860 sends the secondary QoS parameters of the IP layer to the ASN_GW 830 in step 815.

The ASN_GW 830 generates a QoS parameter set for the SF requested by the terminal 810 using the QoS parameters of the IP layer, determines the CS rule and the charging rule in step 817. The QoS parameter set includes the QoS parameters of the MAC layer and the QoS parameters of the IP layer. For example, the QoS parameter set includes the parameters of Table 2 and Table 3. Table 2 shows the QoS parameters of the MAC layer as described in the IEEE 802.16 specification and Table 3 shows the QoS parameters of the present invention. For the requested SF, the QoS parameters of Table 2 and Table 3 are defined. Even for a single SF, the set QoS parameters can be distinguished based on their data type. Among various data transmitted and received in the SF, there can be data which must not be lost because of its considerable importance. Since it is necessary to guarantee the QoS of the data not to be lost at a higher level, the differentiation of the QoS parameters is required based on the data type. For instance, for the higher data significance, the greater number of retransmission times is set.

In step 819, the ASN_GW 830 transmits the QoS parameter set to the terminal 810. At least one of the CS rule and the charging rule can be transmitted together.

When receiving the QoS parameter set, the terminal 810 commences the DSA. That is, the terminal 810 sends a DSA-REQ message to the base station 820 in step 821. The DSA-REQ message includes the QoS parameter set. When the QoS parameters are differentiated based on the data type, the DSA-REQ message includes the type-based QoS parameter information constituted as an array. At this time, a name tag is needed to distinguish the service between the terminal 810 and the ASN_GW 830. The terminal 810 performs the DSA by generating and using a specific name tag per SF. For example, the name tag can utilize PRID which identifies the instance of the policy class.

The base station 820, receiving the DSA-REQ message, confirms the QoS parameters of the MAC layer in the DSA-REQ message from the ASN_GW 830 and conducts the CAC based on the QoS parameters of the MAC layer in step 823.

When the call is accepted as a result of the CAC, the base station 820 informs the ASN_GW 830 of the call acceptance in step 825. Namely, the base station 820 informs the ASN_GW 830 that the extra resource for the terminal 810 is ensured.

The ASN_GW 830 determines whether to permit the requested service. In the exemplary implementation of FIG. 8, it is assumed the service is allowed. The ASN_GW 830 generates a SF for the service and allocates a SF ID in step 827. The ASN_GW 830 determines whether to permit the service as follows.

Firstly, the ASN_GW 830 determines whether to permit the service depending on the call acceptance by the base station 820. When the base station 820 accepts the call, the ASN_GW 830 permits the service. Secondly, the ASN_GW 830 makes a determination by acquiring QoS permitted range information of the corresponding terminal. For doing so, the ASN_GW 830 can obtain the QoS permitted range information from the AAA server 870. When the AAA server 870 provides the QoS permitted range information, the ASN_GW 830 obtains the QoS permitted range information from the AAA server 870 after the authentication of steps 803 and 805.

In step 829, the ASN_GW 830 informs the base station 820 of the service permission. The base station 820 sends a DSA-RSP message to the terminal 810 in step 831. The terminal 810 sends a DSA-ACK message to the base station 820 in step 833.

The service providing server 880 sends a service process inform message. That is, the service providing server 880 sends a 200 OK message of the SIP to the terminal 810 in step 835 and transmits service data in step 837.

The ASN_GW 830 includes the second PDF in FIG. 8. Note that not every ASN_GW in the radio access network includes the second PDF. In other words, the ASN_GW including the second PDF provides the other ASN_GWs with mapping information to generate the QoS parameter set of the radio access network. The ASN_GWs not including the second PDF generate the QoS parameter set of the radio access network for the service requested by the terminal belonging to its coverage using the mapping information. Thus, when the QoS policy is changed, the network manager or the provider can modify the mapping information of the individual ASN_GW by inputting the changed policy only to the control including the second PDF.

Of the NEs in FIG. 8, the IMS server 840 generates the session using the SIP. The IMS server 840 can be replaced by a web server which executes the same function using the HTTP. Alternatively, the IMS server 840 can be divided to one server including the S-CSCF and the I-CSCF and the other server including the P-CSCF.

While the terminal commences the DSA in FIG. 8, the base station can commence the DSA process. In this case, the QoS parameter set of the radio access network is generated as in FIG. 8.

In the exemplary embodiments of the present invention as illustrated in FIGS. 3 through 8, the IMS server, upon confirming the service request through the application layer of the terminal, determines the authentication in association with the AAA server. Note that the authentication determination process between the IMS server and the AAA server can be omitted. Since the authentication of the terminal is determined between the ASN_GW and the AAA server at the initial access, the authentication information before the terminal enters a null mode is managed by the ASN_GW. Hence, whether the terminal is authenticated can be verified over the radio access network. The NEs in the Core Service Network (CSN) do not have to separately authenticate the message which passed the ASN_GW.

To assist in the understanding, it is assumed that the number of the NEs is one. If there are multiple Service Providers (SPs), the number of some of the NEs can be plural, which correspond to the respective SPs. In this situation, an exemplary network architecture of the present invention further includes the following elements.

The terminal transmits the application layer service request message for the service request in various manners. When different SPs operate the server which handles the QoS parameters of the application layer of the various manners, a function for horizontally switching the QoS parameters of the different application layers is provided. For the different functions of the PCRF with the same function of the server which handles the QoS parameters of the different application layers operated by the different SPs, a function for horizontally switching the QoS parameters of the different IP layers is included. For the different first PDFs with the same operation of the server and the PCRF, which handles the QoS parameters of the different application layers operated by the different SPs, a function for horizontally switching the QoS parameters of the different IP layers is included. For the different second PDFs with the same function of the server, the PCRF, and the first PDF, which handles the QoS parameters of the application layers operated by the different SPs, a function for horizontally switching the QoS parameters of the different radio access networks is included.

While the PCRF adopts the same name as the PCRF of the 3GPP, the PCRF of the present invention indicates the function for determining the policy and the charging rule. The first PDF of the present invention corresponds to a PDF of the WiMAX standard, and the second PDF corresponds to a Policy Charging Enforcement Function (PCEF) in the access service network according to the WiMAX standard.

The second PDF may be accommodated in the anchor ASN_GW, or provided as a separate NE in a Network Access Provider (NAP). The second PDF, as a separate NE in a NAP, can communicate with the ASN_GWs of the NAP. As a separate NE, the second PDF can coordinate QoS policies of different Network Service Providers (NSPs) on the whole by communicating with first PDFs of the different NSPs.

The output of the first PDF is the QoS of the IP layer. Yet, when the NAP, as one of the NSPs, controls the first PDF or the authentication server in the CSN, the first PDF can also function as the second PDF similar to the authentication server and take the same QoS and charging policy as the authentication server and the first PDF. Alternatively, when the NAP forwards the QoS mapping relation of the QoS of the IP layer and the QoS of the radio access network to the first PDF of each NSP, the first PDF can operate as mentioned earlier. The mapping relation of the NAP is forwarded on-line or off-line when the business contract is made or the QoS policy for the radio access network is changed.

Either the terminal or the base station can commence the SF generation. When the terminal initiates the SF generation, the terminal acquires the QoS parameters required to generate the SF by including the first PDF function and the second PDF function or by receiving the outputs of the first PDF and the second PDF through the application layer responses. When using the parameter indicative of 1-bit control information relating to whether the first PDF functions as the second PDF, the ASN_GW can determine whether to serve as the second PDF depending on the 1-bit control information.

Some of the parameters of Table 2 and Table 3 can be used in the application layer, the IP layer, and the MAC/PHY layer in common. Only ‘grant interval’ is used in the MAC layer alone. One of the parameters only in the MAC/PHY layer concerns the request/transmission policy and includes fragmentation or not, packing or not, compression or not, compression scheme, ARQ adoption or not, and HARQ adoption or not.

An additional exemplary embodiment that is beside the exemplary embodiments of the present invention as illustrated in FIGS. 3 through 8 is explained below. A AAA server includes a PDF and has information on service profile IDs and QoS parameter sets. And the AAA server selects one service profile ID which has proper QoS parameter set for service requested from a terminal. Then, the AAA server sends the service profile ID to a ASN_GW. It is assumed that the ASN_GW already knows all service profile IDs and QoS parameter sets corresponding each service profile ID. That is, service profile IDs and QoS parameter sets corresponding each service profile ID are stored at the ASN_GW by system operator at offline. Hence, the ASN_GW generates service flow using proper QoS parameter set of the radio access network for the terminal.

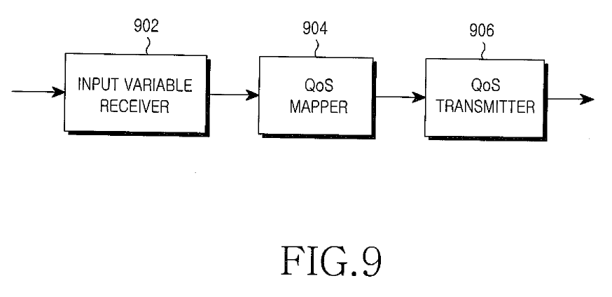

FIG. 9 is a block diagram illustrating a policy function device in a communication network according to an exemplary embodiment of the present invention. Herein, the policy function device is a device having the policy function. The policy function device of FIG. 9 can be included in the IMS server, the web server, or the terminal. Particularly, the policy function device of FIG. 9 includes the PCRF and the PDF as in the exemplary embodiments of the present invention as aforementioned.

Referring to FIG. 9, the PDF device includes a variable input part 902, a QoS mapper 904, and a QoS transmitter 906.

The variable input part 902 receives the input variables required to constitute the QoS parameter set. The variable input part 902 provides the input variables to the QoS mapper 904. For example, the input variables include the application layer QoS information of Table 1 and the terminal's authentication information.

The QoS mapper 904 constitutes the QoS parameter set using the input variables. The QoS parameter set is the IP layer QoS parameters and the MAC layer parameters for the ASN_GW and the base station, and includes the information of Table 2 and Table 3 as an example. The QoS mapper 904 determines the CS rule for distinguishing the multiple SFs of one terminal. Even for a single SF, the QoS parameters can be distinguished based on the data type.

The QoS transmitter 906 sends the QoS parameters set and the CS rule to the terminal which requested the service.

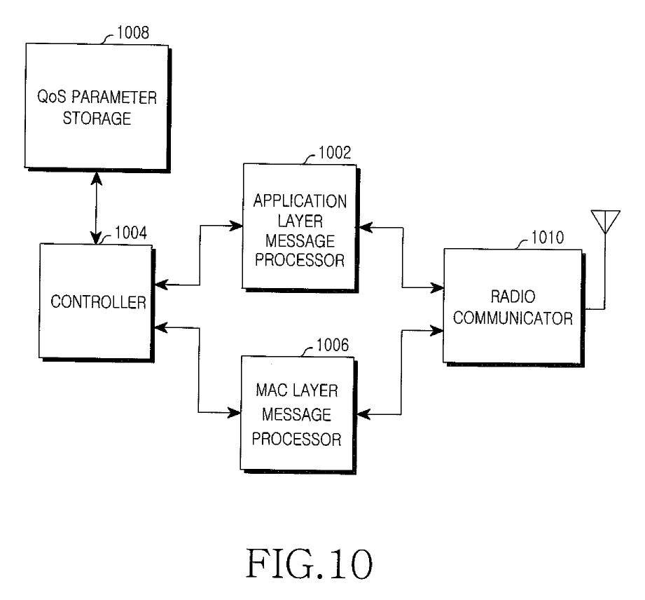

FIG. 10 is a block diagram illustrating a terminal in a communication network according to an exemplary embodiment of the present invention.

Referring to FIG. 10, the terminal includes an application layer message processor 1002, a controller 1004, a MAC layer message processor 1006, a QoS parameter storage 1008, and a radio communicator 1010.

The application layer message processor 1002 generates and translates the message of the application layer. For example, the application layer message processor 1002 generates the service request message of the application layer and translates the service request response message and the service process inform message. Particularly, the application layer message processor 1002 interprets the application layer message including the QoS parameter set received from the policy function device. Herein, the application layer message including the QoS parameter set can also include the CS rule. The QoS parameter set can include the QoS parameter information differentiated based on the data type.

The controller 1004 controls the functions of the terminal. For instance, when confirming the execution of an application program by the user, the controller 1004 controls the application layer message processor 1002 to generate the service request message for requesting the service to the correspondent node. Particularly, when the QoS parameter set is received from the policy function device through the message of the application layer, the controller 1004 controls the MAC layer message processor 1006 to generate the DSA-REQ message to commence the DSA.

In transition to the sleep mode and the idle mode, the controller 1004 stores the SF operation state of the awake mode. When UL traffic is generated for the SF of the standby mode, the controller 1004 changes the corresponding SF to the active mode through the DSC. That is, the controller 1004 controls the MAC layer message processor 1006 to generate the DSC-REQ message.

The MAC layer message processor 1006 generates and interprets the MAC layer message exchanged with the base station. Particularly, the MAC layer message processor 1006 generates the DSA-REQ message to be sent to the base station. Herein, the DSA-REQ message includes the QoS parameters received using the application layer message. When the QoS parameters are differentiated based on the data type, the DSA-REQ message includes the type-based QoS parameter information constituted as the array. When the application layer message delivers the CS rule, the DSA-REQ message includes the CS rule.

The QoS parameter storage 1008 stores the QoS parameter set received using the application layer message. The radio communicator 1010 processes signals to communicate with the base station in the radio channel. For example, the radio communicator 1010 demodulates and converts a transmit bit stream to complex symbols, and generates Orthogonal Frequency Division Multiplexing (OFDM) symbols through Inverse Fast Fourier Transform (IFFT) operation. The radio communicator 1010 up-converts the generated signal to a Radio Frequency (RF) signal and transmits the RF signal over an antenna.

The terminal of FIG. 10 does not include the policy function. If including the policy function, the terminal includes a mapper which performs the same functions as the QoS mapper 904 of FIG. 9. The application layer message processor 1002 translates the application layer message including the authentication information and provides the authentication information to the mapper. The controller 1004 provides the application layer QoS information to the mapper.

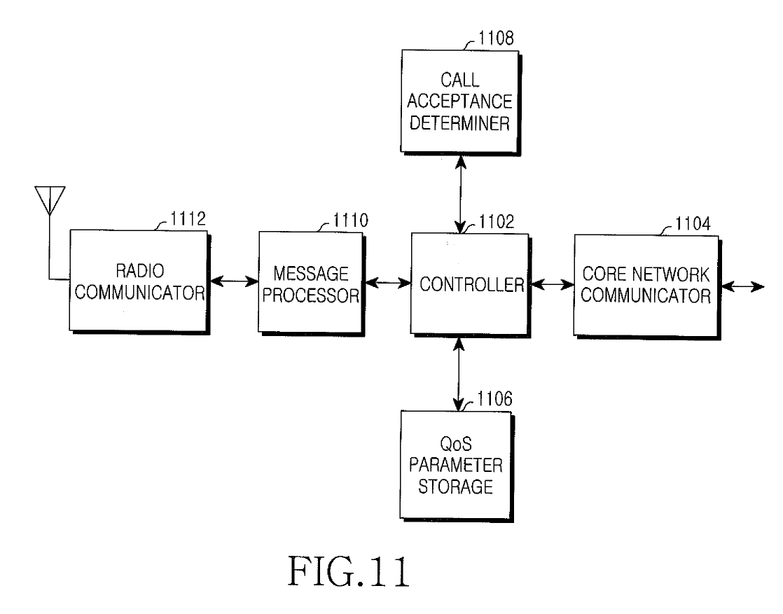

FIG. 11 is a block diagram illustrating a base station in a communication network according to an exemplary embodiment of the present invention. The base station of FIG. 11 commences the DSA procedure as in other exemplary embodiments of the present invention.

Referring to FIG. 11, the base station includes a controller 1102, a core network communicator 1104, a QoS parameter storage 1106, a call acceptance determiner 1108, a message processor 1110, and a radio communicator 1112.

The controller 1102 controls the functions of the base station. Particularly, when receiving the QoS parameter information from the ASN_GW for the DSA execution with the terminal, the controller 1102 operates the call acceptance determiner 1108. When the call is accepted according to the determination of the call acceptance determiner 1108, the controller 1102 controls to inform the ASN_GW of the call acceptance, to allocate the TCID to the terminal, and to execute the DSA with the terminal.

In the transition to the sleep mode and the idle mode, the controller 1102 remembers the SF operation state of the awake mode. When DL traffic is generated for the SF of the standby mode, the controller 1102 changes the corresponding SF to the active mode through the DSC procedure. That is, the controller 1102 controls the MAC layer message processor 1110 to generate the DSC-REQ message.

The core network communicator 1104 processes the signal transmission and reception for communications between the ASN_GW and the base station. The QoS parameter storage 1106 stores the QoS parameters received from the ASN_GW to refer to them in the DSA and communications with the terminal. The call acceptance determiner 1108 determines whether the call is accepted with respect to the terminal which requested the service. In doing so, the call acceptance determiner 1108 determines whether the call can be accepted; that is, the call acceptance determiner 1108 determines whether the resource can be ensured, based on the MAC layer QoS parameter information received from the ASN_GW.

The message processor 1110 generates the MAC message to be sent to the terminal and interprets the MAC message received from the terminal. For instance, the message processor 1110 generates the DSA-REQ message under the control of the controller 1102. The radio communicator 1112 processes signals for communications with the terminal. For instance, the radio communicator 1112 converts a bit stream to complex symbols by decoding and modulating the bit stream, and generates OFDM symbols through the IFFT operation. The radio communicator 1112 up-converts the generated signal to an RF signal and transmits the RF signal via an antenna.

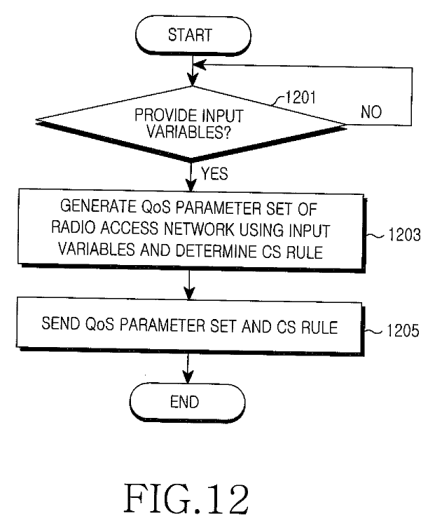

FIG. 12 is a flowchart illustrating operations of a policy function device in a communication network according to an exemplary embodiment of the present invention. Herein, the policy function device indicates the NE which acts as the policy function. The policy function device can be an independent policy function entity, the IMS server, the web server, the terminal, or the ASN_GW.

Referring to FIG. 12, in step 1201, the policy function device determines whether the input variables required to constitute the QoS parameter set of the radio access network are provided or not. The input variables are the application layer QoS information for the service requested by the terminal. The input variables include, as an example, the information of Table 1 and the authentication information of the terminal.

When the input variables are provided, the policy function device generates the QoS parameter set of the radio access network and the CS rule using the input variables and the authentication information in step 1203. The QoS parameter set of the radio access network includes the IP layer QoS parameters and the MAC layer QoS parameters to be used by the ASN_GW, the base station, and the terminal, and includes, by way of example, the parameters of Table 2 and Table 3.

In step 1205, the policy function device transmits the QoS parameter set of the radio access network and the CS rule to the NE which performs the DSA procedure. More specifically, when the terminal commences the DSA procedure as in one or more previously described exemplary embodiments of the present invention, the policy function device transmits the QoS parameter set of the radio access network and the CS rule to the terminal which requested the service. When the base station commences a DSA procedure, the policy function device transmits the QoS parameter set of the radio access network and the CS rule to the base station which manages the terminal requesting the service.

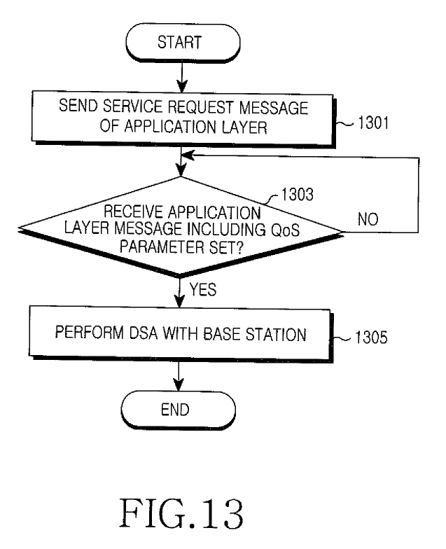

FIG. 13 is a flowchart illustrating operations of a terminal in a communication network according to an exemplary embodiment of the present invention, where the policy function is not provided as in a previously described exemplary embodiment of the present invention and the terminal commences the DSA procedure.

Referring to FIG. 13, in step 1301, the terminal transmits the service request message of the application layer. The service request message of the application layer can be, for example, the INVITE message of the SIP.

In step 1303, the terminal determines whether the application layer message including the QoS parameter set of the radio access network is received or not. Herein, the application layer message may be a response message for the service request message, or a separate message to carry the QoS parameter set. For example, the application layer message can be the 183 message of the SIP.

Upon receiving the application layer message including the QoS parameter set, the terminal performs the DSA with the base station using the QoS parameter set in step 1305. In other words, the terminal generates and transmits the DSA-REQ message including the QoS parameter set. When receiving the DSA-REP message from the base station, the terminal transmits the DSA-ACK message.

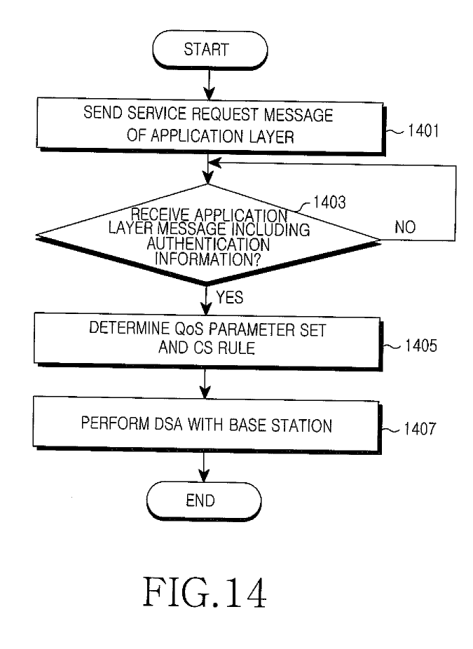

FIG. 14 is a flowchart illustrating a QoS management operation of a terminal in the communication network according to another exemplary embodiment of the present invention, where the policy function is provided as in a previously described exemplary embodiment of the present invention and the terminal initiates the DSA procedure.

Referring to FIG. 14, in step 1401, the terminal transmits the service request message of the application layer. The service request message of the application layer can be, as an example, the INVITE message of the SIP.

In step 1403, the terminal determines whether the application layer message including the authentication information of the terminal is received or not. Herein, the application layer message may be a response message for the service request message, or a separate message to carry the authentication information. The application layer message can be, for example, the 183 message of the SIP.

Upon receiving the application layer message including the authentication information, the terminal generates the QoS parameter set of the radio access network. That is, the terminal generates the QoS parameter set of the MAC layer and the IP layer using the authentication information and the QoS information of the application layer in step 1405. For example, the QoS parameter set includes the parameters of Table 2 and Table 3. Also, the terminal determines the CS rule.

In step 1407, the terminal performs the DSA with the base station using the QoS parameter set. In further detail, the terminal generates and transmits the DSA-REQ message including the QoS parameter set and the CS rule. When receiving the DSA-REP message from the base station, the terminal sends the DSA-ACK message.

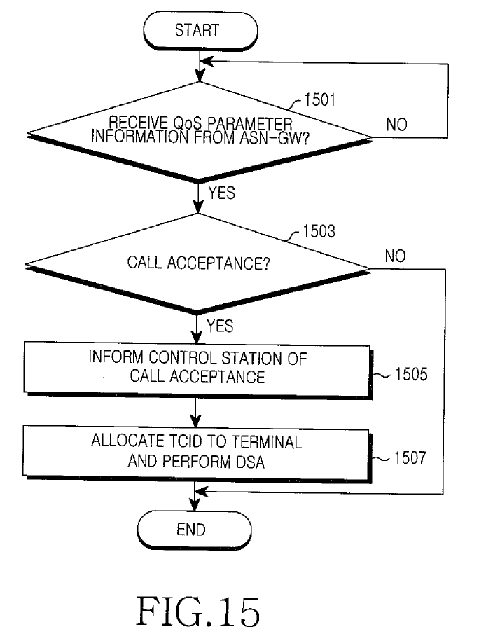

FIG. 15 is a flowchart illustrating operations of a base station in a communication network according to another exemplary embodiment of the present invention, where the base station commences the DSA procedure as previously described in an exemplary embodiment of the present invention.

Referring to FIG. 15, in step 1501, the base station determines whether the QoS parameter information of the MAC layer is received from the ASN_GW. Namely, the base station determines whether the information required to execute the DSA procedure is received from the ASN_GW.

When receiving the QoS parameter information, the base station determines whether the call is acceptable, by performing the CAC for the terminal which requested the service in step 1503. In other words, the base station determines whether the resource for servicing the terminal can be ensured. The CAC is executed based on the QoS parameters of the MAC layer received from the ASN_GW.

When the call is accepted, the base station informs the ASN_GW of the call acceptance in step 1505.

In step 1507, the base station allocates the TCID to the terminal and performs the DSA. More specifically, the base station generates the DSA-REQ message including the TCID and the MAC layer QoS parameters and transmits the DSA-REQ message to the terminal. When receiving the DSA-RSP message from the terminal, the base station transmits the DSA-ASK message in response.

In a broadband communication network, the QoS parameters of the radio access network are generated using the QoS parameters of the application layer and provided to the NEs. Consequently, the end-to-end QoS can be guaranteed.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A communication network architecture comprising:
a terminal for transmitting an application layer service request message to request a service;
a Policy Charging Rule Function (PCRF) for generating Quality of Service (QoS) parameters of an Internet Protocol (IP) layer using QoS parameters of an application layer contained in the application layer service request message;
a first Policy Decision Function (PDF) for generating one or more QoS parameters of the IP layer in addition to the IP layer QoS parameters generated at the PCRF; and
a second PDF for generating a QoS parameter set of a radio access network using the IP layer QoS parameters generated at the PCRF and the one or more IP layer QoS parameters generated at the first PDF.

2. The communication network architecture of claim 1, wherein the first PDF comprises a Network Entity (NE) included in a core network, and
the second PDF comprises an NE included in the radio access network.

3. The communication network architecture of claim 1, wherein the second PDF comprises part of a Access Service Network_GateWay (ASN_GW) which acts as an upper node of a plurality of base stations in the radio access network.

4. The communication network architecture of claim 1, wherein the second PDF generates the QoS parameter set of the radio access network, the QoS parameter set comprising at least one of Media Access Control (MAC) layer QoS parameters, IP layer QoS parameters, a parameter as to whether an IP header is compressed or not and a compression scheme, a parameter as to whether a Traffic Encryption Key (TEK) is used or not, a parameter as to whether Dynamic Service Change (DSC) is permitted or not, a parameter as to a number of times of DSC permission per Service Flow (SF), a parameter as to whether an active SF is changed to a provision SF using the DSC, a parameter as to whether a mode change timer from the active mode to the provision mode is allowed per SF, a parameter as to a mode change timer value per SF, a parameter as to a service reliability, a parameter as to a condition to forcibly release a call, a parameter as to whether an Automatic Repeat reQuest (ARQ) is performed, a parameter as to a symmetric service, a parameter as to whether it is possible to hand over to another provider network using the same radio technology, a parameter as to whether it is possible to hand over to another radio network using a different radio technology, and a parameter as to an initial access request processing scheme which exceeds a limited number of awakened terminals.

5. The communication network architecture of claim 1, wherein the second PDF classifies a data type according to significance in one SF, and differently sets the QoS parameters based on the data type.

6. The communication network architecture of claim 1, further comprising:
a base station for performing a Call Admission Control (CAC) based on the QoS parameter set of the radio access network; and
a ASN_GW for, when being informed of a call acceptance as a result of the CAC, determining whether to permit the service based on the QoS parameter set of the radio access network.

7. The communication network architecture of claim 6, wherein, for at least one of every service request and a network entry of the terminal, the ASN_GW acquires QoS permitted range information of the terminal from the second PDF and determines whether to permit the service based on the QoS permitted range information.

8. The communication network architecture of claim 6, wherein the ASN_GW acquires QoS permitted range information of the terminal from an Authentication Authorization Accounting (AAA) server, and determines whether to permit the service based on the QoS permitted range information.

9. The communication network architecture of claim 6, wherein, when a call is accepted as a result of the CAC of the base station, the ASN_GW permits the service without a separate procedure.

10. The communication network architecture of claim 6, wherein the ASN_GW determines whether to permit the service based on information received from the second PDF.

11. The communication network architecture of claim 1, wherein the terminal wirelessly communicates using an Orthogonal Frequency Division Multiple Access (OFDMA) scheme.

12. The communication network architecture of claim 1, wherein the terminal commences a Dynamic Service Addition (DSA) procedure using the QoS parameter set of the radio access network.

13. The communication network architecture of claim 1, further comprising:
a base station for commencing a DSA procedure using the QoS parameter set of the radio access network.

14. A communication network architecture comprising:
a terminal for transmitting an application layer service request message to request a service;
a Policy Charging Rule Function (PCRF) for generating Quality of Service (QoS) parameters of an Internet Protocol (IP) layer using QoS parameters of an application layer contained in the application layer service request message; and
a Policy Decision Function (PDF) for generating a QoS parameter set of at least one of a radio access network and one or more QoS parameters of the IP layer in addition to the IP layer QoS parameters generated at the PCRF using the QoS parameters of the IP layer.

15. The communication network architecture of claim 14, wherein the PDF generates the QoS parameter set of the radio access network, the QoS parameter set comprising at least one of Media Access Control (MAC) layer QoS parameters, IP layer QoS parameters, a parameter as to whether an IP header is compressed or not and a compression scheme, a parameter as to whether a Traffic Encryption Key (TEK) is used or not, a parameter as to whether Dynamic Service Change (DSC) is permitted or not, a parameter as to a number of times of DSC permission per Service Flow (SF), a parameter as to whether an active SF is changed to a provision SF using the DSC, a parameter as to whether a mode change timer from the active mode to the provision mode is allowed per SF, a parameter as to a mode change timer value per SF, a parameter as to a service reliability, a parameter as to a condition to forcibly release a call, a parameter as to whether an Automatic Repeat reQuest (ARQ) is performed, a parameter as to a symmetric service, a parameter as to whether it is possible to hand over to another provider network using the same radio technology, a parameter as to whether it is possible to hand over to another radio network using a different radio technology, and a parameter as to an initial access request processing scheme which exceeds a limited number of awakened terminals.

16. The communication network architecture of claim 14, wherein the PDF classifies a data type according to significance in one SF, and differently sets the QoS parameters based on the data type.

17. The communication network architecture of claim 14, wherein the PCRF transmits a control bit for determining output information of the PDF, and
the PDF performs at least one of outputting of the QoS parameter set of the radio access network and selectively outputting of the IP layer QoS parameters generated at the PCRF and the generated one or more IP layer QoS parameters according to the control bit.

18. The communication network architecture of claim 14, further comprising:
a base station for performing a Call Admission Control (CAC) based on the QoS parameter set of the radio access network; and
a Access Service Network_GateWay (ASN_GW) for, when being informed of a call acceptance as a result of the CAC, determining whether to permit the service based on the QoS parameter set of the radio access network.

19. The communication network architecture of claim 14, wherein the terminal wirelessly communicates using an Orthogonal Frequency Division Multiple Access (OFDMA) scheme.

20. The communication network architecture of claim 14, wherein the terminal commences a Dynamic Service Addition (DSA) procedure using the QoS parameter set of the radio access network.

21. The communication network architecture of claim 14, further comprising:
a base station for commencing a DSA procedure using the QoS parameter set of the radio access network.

22. A communication network architecture comprising:
a terminal for transmitting an application layer service request message to request a service;
a first server for managing user class information of the terminal;
a second server for acquiring Quality of Service (QoS) information of an application layer from the service request message of the terminal; and
a policy function for generating a QoS parameter set of a radio access network using the application layer QoS information and the user class information.

23. The communication network architecture of claim 22, wherein the policy function generates the QoS parameter set which comprises at least one of Media Access Control (MAC) layer QoS parameters, IP layer QoS parameters, a parameter as to whether an IP header is compressed or not and a compression scheme, a parameter as to whether a Traffic Encryption Key (TEK) is used or not, a parameter as to whether Dynamic Service Change (DSC) is permitted or not, a parameter as to a number of times of DSC permission per Service Flow (SF), a parameter as to whether an active SF is changed to a provision SF using the DSC, a parameter as to whether a mode change timer from the active mode to the provision mode is allowed per SF, a parameter as to a mode change timer value per SF, a parameter as to a service reliability, a parameter as to a condition to forcibly release a call, a parameter as to whether an Automatic Repeat reQuest (ARQ) is performed, a parameter as to a symmetric service, a parameter as to whether it is possible to hand over to another provider network using the same radio technology, a parameter as to whether it is possible to hand over to another radio network using a different radio technology, and a parameter as to an initial access request processing scheme which exceeds a limited number of awakened terminals.

24. The communication network architecture of claim 22, wherein the application layer QoS information comprises at least one of media type information, a port number, an indication of real-time or not, codec information, a network address, an IP type, and a required traffic rate.

25. The communication network architecture of claim 22, wherein the policy function comprises a separate server connected to a core network.

26. The communication network architecture of claim 22, wherein the policy function comprises a part of the terminal.

27. The communication network architecture of claim 22, wherein the policy function comprises a part of the second server.

28. The communication network architecture of claim 22, wherein the policy function classifies a data type according to significance in one SF, and differently sets the QoS parameters based on the data type.

29. The communication network architecture of claim 22, further comprising:
a base station for communicating with the terminal in a radio channel and performing a Call Admission Control (CAC) based on a QoS parameter set of a radio access network; and
a Access Service Network_GateWay (ASN_GW) for, when being informed of a call acceptance as a result of the CAC, determining whether to permit the service based on the QoS parameter set of the radio access network.

30. The communication network architecture of claim 29, wherein, for at least one of every service request and a network entry of the terminal, the ASN_GW acquires QoS permitted range information of the terminal from the policy function and determines whether to permit the service based on the QoS permitted range information.

31. The communication network architecture of claim 29, wherein the ASN_GW acquires QoS permitted range information of the terminal from the first server after authenticating the terminal, and determines whether to permit the service based on the QoS permitted range information.

32. The communication network architecture of claim 29, wherein, when a call is accepted as a result of the CAC of the base station, the ASN_GW permits the service without a separate procedure.

33. The communication network architecture of claim 29, wherein the ASN_GW determines whether to permit the service based on information received from the policy function.

34. The communication network architecture of claim 22, wherein the terminal wirelessly communicates using an Orthogonal Frequency Division Multiple Access (OFDMA) scheme.

35. The communication network architecture of claim 22, wherein the terminal commences a Dynamic Service Addition (DSA) procedure using the QoS parameter set of the radio access network.

36. The communication network architecture of claim 22, further comprising:
a base station for commencing a DSA procedure using the QoS parameter set of the radio access network.

37. A communication network architecture comprising:
a terminal for transmitting an application layer service request message to request a service;
a first function for horizontally switching Quality of Service (QoS) parameters of different application layers between Service Providers (SPs) when a server which handles QoS parameters of an application layer is operated by different SPs;
a second function for horizontally switching QoS parameters of different IP layers when a server function for handling QoS parameters of application layers operated by different SPs is the same but a Policy Charging Rule Function (PCRF) is different;
a third function for horizontally switching QoS parameters of different IP layers when a server and a PCRF for handling QoS parameters of application layers operated by different SPs operate the same but a first Policy Decision Function (PDF) is different; and
a fourth function for horizontally switching QoS parameters of different radio access networks when a server, a PCRF, and a first PDF for handling QoS parameters of application layers operated by different SPs operate the same but a second PDF is different.
